(19) United States
(12) Patent Application Publication
(10) Pub. No.: US 2025/0348962 A1
(43) Pub. Date: Nov. 13, 2025

(54) VIRTUAL MARKETSPACE SMART NEGOTIATION

(71) Applicant: QONECTIN, San Francisco, CA (US)

(72) Inventors: Jorge Elias "Jorel" CARCAMO, San Francisco, CA (US); Claudia Cecilia CARCAMO, San Francisco, CA (US)

(73) Assignee: QONECTIN, San Francisco, CA (US)

(21) Appl. No.: 19/272,741

(22) Filed: Jul. 17, 2025

Related U.S. Application Data
(63) Continuation of application No. 18/124,436, filed on Mar. 21, 2023.
(60) Provisional application No. 63/322,626, filed on Mar. 22, 2022.

(51) Int. Cl. G06Q 50/16; G06Q 30/0283; G06Q 30/08

(52) U.S. Cl. CPC G06Q 50/167; G06Q 30/0283; G06Q 30/08

(57) ABSTRACT

A graphical user interface including an interactive graphical component representing a seller's offer to sell a property and at least one offer to purchase a property. The interactive graphical component including, for the at least one offer to purchase the property, a first polygon extending from an axis to represent a net offer price and a second polygon extending from the axis to represent a point value. The point value being generated by a model using a plurality of offer inputs. The graphical user interface, responsive to receiving at least one updated offer associated with the at least one offer to purchase the property, includes an updated graphical component with a first revised polygon representing the updated point value in a position of the second polygon to represent the point value for the at least one updated offer.

### CROSS REFERENCE TO RELATED APPLICATIONS

This application is a continuation of U.S. patent application Ser. No. 18/124,436, filed Mar. 21, 2023, which claims priority under 35 U.S.C. § 119 to U.S. Provisional Application No. 63/322,626, filed Mar. 22, 2022, each of which is incorporated by reference herein in its entirety.

### TECHNICAL FIELD

This application relates generally to the use of a collaborative platform using modeling and unique graphical user interfaces for communication and transactions.

### BACKGROUND

The traditional marketplace for purchasing and selling property is an obsolete workflow system. Traditional transactions in real estate involve a buyer agent working on behalf of a buyer and a seller agent working on behalf of a seller to effectuate the buyer's and seller's desires. This method of conducting business is a slow, disconnected process, and only necessitated because of conventional technology's inabilities in analyzing and displaying complex real estate information to a typical buyer and seller. Traditional property transactions are arduous; done by hand or computer; submitted via email, fax, postal mail, or hand delivered; negotiated over the phone or text; accepted over phone or text; and confirmed via email. Negotiations often comprise multiple buyers and occur over the course of weeks or even months. As such, this process often requires agents to assist a buyer and seller in navigating the transaction process. This system has obstacles, frictions, and biases that negatively affect buyers and sellers. The traditional method is flawed as it is agent-centric and because current technology does not adequately allow a typical buyer or seller to access, understand and conduct the negotiation process on their own. For example, a typical seller of a property (or his/her agent) does not have the time or expertise to manage multiple offers, even dozens or hundreds, for a single property. It would be too inefficient and time-consuming for a lay seller (or his/her agent) to process multiple offers in real time with current technological solutions. Conventional graphical user interfaces (“GUIs”) do not efficiently communicate the most relevant information to a seller or buyer when negotiating real estate transactions. Conventional models do not adequately compare offers for a lay seller or buyer to understand. As a result, transactions are delayed, negotiations cannot happen in real time, and opportunities and productivity are lost: all of this stemming from technical problems arising from current technical limitations in analyzing/displaying complex and multi-faceted offers to purchase property.

Additionally, buyers are limited by the current technology of the real estate market. For example, sellers often compare offers on characteristics of the offer beyond the net offer price. For example, the percent down paid, the waiver of inspections, etc. Conventional solutions do not currently assist a typical buyer in crafting a competitive offer to purchase a property based on the preferences of the seller. Instead, in today's market, a home is simply placed as a listing with a listed asking price with very little additional information about the offer preferences of the seller. This often results in potential buyers making offers below or beyond what is necessary, leaving sellers with less desirable offers, and excluding a multitude of potential buyers.

### SUMMARY

What is needed is a novel marketplace system where sellers, buyers, and agents can perform sales offer workflow with associated models, smart analyses, and easily understood GUIs for property transactions. Specifically, what is needed is a novel buyer/seller-centric system with efficient analysis and communication of information (through novel and unique GUIs and dashboards) related to the generation and comparison of offers to purchase property, and that can separate the seller's, buyer's, and agent's individual interests. A new model and system is needed for conducting the true fair market value negotiation process to increase the efficiency of generating offers, analyzing individual offers, submitting offers, analyzing multiple offers in real time, negotiating with multiple buyers, processing multiple offers, and accepting offers. A new, inclusive model and system is needed to eliminate obstacles and allow all to engage in the purchase and sale of property.

The present disclosure relates to various technical solutions to the above-mentioned technical problems. According to one implementation, the present disclosure relates to a novel system with various models (e.g., an artificial intelligence model) used for analyzing data associated with multiple offers for a property, generating a point value (e.g., a singular, representative value) to represent each offer, and displaying the offers and the generated point values associated with the offers in a unique and interactive GUI to allow a seller to compare multiple multi-faceted offers quickly and efficiently. In one embodiment, the interactive GUI includes an interactive bar graph with a bar representing a net offer price and a bar representing the generated point value associated with the net offer price. In some embodiments, multiple offers are represented on the same interactive GUI. This allows the seller to quickly and efficiently compare offers on an “apples-to-apples” basis by taking into account the various (and differing) terms and conditions of each offer. This results in better educated and quicker negotiations, as the seller is able to make more targeted counteroffers quicker and view the most competitive offer at a glance without needing to wade through forms of offer details (as is traditionally done). The point value is generated based on the characteristics of the offer. In some embodiments, the point value is an aggregation of each characteristic of the offer based on a seller's preference. In some embodiments the seller may prefer the highest net offer. In others, the seller may prefer more money down. Regardless of the preferences, the model of the present disclosure is able to generate a singular value for facilitated comparison.

In some embodiments, the system relays notifications to various users (buyers, sellers, financial institutions, agents, etc.) based on another user's interactions with the system. For example, once a seller accepts an offer, all buyers with pending offers (other than the accepted offer) may automatically receive notifications that their offer has been rejected. In some embodiments, when a notification alerts the buyer to a counteroffer made by the seller, the notification may include options to improve the offer. This technical solution solves the technical problem of needing to access a separate application (e.g., by opening a separate application and signing in) to update an offer. This increases the speed of the negotiation and makes the overall transaction more efficient and fair to all parties (particularly important in today's fast-paced economy).

In addition, this more efficient and fair system aids in the separation of interests and provides more transparency in the market. For example, sellers are awarded more transparency because they are able to view the offers received in real time without an agent's filtering. Buyers are awarded more transparency because they are notified when higher offers are received and thus know where they stand in the bidding process. This system also provides for a separation of interests because when the buyer and seller are more involved in the transactional process, they are more able to direct the process. When the buyer and seller are directing the process they are more likely choose to pursue strategies that best benefit themselves. In contrast, a seller's agent and a buyer's agent may put their own interest above that of their client when the directing the transaction without actively seeking the client's input or direction.

In another implementation, the present disclosure relates to a novel system with various models (e.g., an artificial intelligence model) used for analyzing data associated with a property for sale and a buyer's financial goals, generating a most competitive offer (and accompanying affordability threshold) based on financial constraints and a buyer's preferences, generating comparable property values, and displaying the comparable property values in relation to the most competitive offer and accompanying affordability threshold. This novel system may be hosted and executed on a computer or mobile phone application. In some embodiments, the computer or mobile phone application may be named “Virtual Marketspace.” In some embodiments, the system of the present disclosure generates an affordability threshold of the buyer based on a buyer's financial goals and inputs. This can be generated by an artificial intelligence model that uses both buyer inputs and macroeconomic analysis. In some embodiments, generated comparable property values and the affordability threshold are displayed on an interactive GUI. In some embodiments, the comparable suggested values and the asking price are represented by bars on a bar graph. The affordability threshold is represented by a horizontal line that may or may not intersect the comparable suggested values or the asking price, depending on the value of the affordability threshold. By displaying the affordability threshold in relation to the comparable suggested values and the asking price, the buyer is able to quickly determine how competitive the buyer may be in a negotiation. It also allows a buyer, during negotiations, to quickly determine whether to improve the offer price, accept, reject, or counter a seller's counteroffer. This increases the speed of the negotiation and makes the overall transaction fair, inclusive, transparent, and more efficient (particularly important in today's fast-paced economy). This increase in efficiency and productivity is not possible with the current technological solutions used today (e.g., waiting for the end of a bidding period, calculating by hand how much is possible to spend, assuming the seller is only concerned with the net offer price, resubmitting a counteroffer to an agent, etc.). Additionally, the interactive GUI may allow the buyer to modify the affordability threshold by interacting with the graphical components of the graph. In doing so, the model (e.g., an artificial intelligence model) may update the buyer's financial inputs/preferences in real time to reflect the updated affordability threshold. In one example, by increasing the affordability threshold, the model may reflect an increase in the amount the buyer can pay for the property by updating the buyer's financial inputs in real time (e.g., increasing the down payment amount). The model is configured to change the buyer's financial preferences/inputs only to the degree that the buyer is able to satisfy the offer if accepted.

In some embodiments, the buyer may view the point value of the buyer's offer. In some embodiments, the buyer may view the buyer's offer in relation to the price range suggested by the comparable market analysis. In some embodiments, the buyer may view the buyer's point value of the buyer's offer in relation to the other offers received by the seller. This, once again, accelerates the negotiation process and allows a typical buyer to be completely involved in the transaction of the property, thus reducing the drawbacks of the current agent-centric system. In some embodiments, the user may interact with the GUI to generate a maximum point value. This allows a buyer to offer a most-competitive offer in relation to the seller's preferences and the property's true market value. This is not possible to efficiently and accurately do with today's current technology of simply displaying the asking price of the property.

The present disclosure solves the current technical problems with comparing, analyzing, and displaying data to the lay buyer/seller to empower the buyer/seller to conduct the transaction of a property on their own with or without an agent.

According to some implementations, the present disclosure relates to a method of presenting for display a graphical user interface on an user device, the method including receiving, by a server, at least one offer to purchase a property; applying, by the server, a model configured to value the at least one offer by inputting a plurality of offer inputs and outputting a point value based on the plurality of offer inputs; presenting, by the server, for display in a region of the graphical user interface, an interactive graphical component representing the at least one offer to purchase the property, wherein the interactive graphical component includes, for the at least one offer, a first polygon extending from an axis to represent a net offer price and a second polygon extending from the axis to represent the point value; and responsive to receiving, by the server, at least one updated offer associated with the at least one offer to purchase the property: applying, by the server, the model to an updated plurality of offer inputs and outputting an updated point value; and presenting, by the server, for display an updated graphical user interface having an updated interactive graphical component to include a first revised polygon representing the updated point value in a position of the second polygon representing the point value for the at least one updated offer.

In some embodiments, the method further includes presenting, by the server, for display in a second region of the graphical user interface, a second interactive graphical component representing the at least one offer to purchase the property; wherein the second interactive graphical component includes an offeror associated with the at least one offer to purchase the property; and wherein the second interactive graphical component displays the plurality of offer inputs associated with the at least one offer to purchase the property.

In another embodiment, the method further includes presenting, by the server, for display in a third region of the graphical user interface, a third interactive graphical component representing an offeror's investment and the point value; wherein both the offeror's investment and the point value are associated with the at least one offer to purchase the property; wherein the offeror's investment is displayed graphically on a third polygon extending from a second axis to represent the offeror's investment in the at least one offer to purchase the property; and wherein the point value is displayed graphically on a fourth polygon extending from the second axis to represent the point value.

In another embodiment, the method further includes responsive to receiving, by the server, an interaction with the interactive graphical component; presenting, by the server, for display at least one of the plurality of offer inputs associated with the at least one offer to purchase the property.

In another embodiment, the method further includes presenting, by the server, for display a receipt notification on the user device; wherein the receipt notification is associated with the at least one updated offer to purchase the property.

In another embodiment, the plurality of offer inputs includes at least one of an offer price, a percent down payment, a days to close on escrow, a whether the at least one offer is contingent on a sale of another house, and a contingency time period.

According to another implementation, the present disclosure relates to a method of presenting for display a graphical user interface on an user device, the method including receiving, by a server, at least one offer to sell a property applying, by the server, a model configured to value the property and generate an affordability threshold by inputting a plurality of property inputs and a plurality of pricing inputs and outputting a suggested comparable value, a lower comparable suggested value of the property, an upper comparable suggested value of the property, and the affordability threshold; wherein the lower comparable suggested value is based at least on a comparable suggested value; wherein the upper comparable suggested value is based at least on the comparable suggested value; wherein the affordability threshold is based at least on a user's maximum comfortable monthly payment; presenting, by the server, for display in a first region of the graphical user interface, an interactive graphical component representing the at least one offer to sell the property, wherein the interactive graphical component includes, for the property: a first polygon extending from an axis to represent an asking price of the property; a second polygon extending from the axis to represent the comparable suggested value of the property; a third polygon extending from the axis to represent the lower comparable suggested value of the property; a fourth polygon extending from the axis to represent the upper comparable suggested value of the property; and a first affordability threshold marker to represent the affordability threshold; responsive to receiving, by the server, at least one offer to purchase the property: applying, by the server, the model to the plurality of property inputs, the plurality of pricing inputs, and a plurality of offer inputs and outputting an updated affordability threshold; and presenting, by the server, for display a fifth polygon extending from the axis to represent the at least one offer to purchase the property and a second affordability threshold marker in a position of the first affordability threshold marker to represent the updated affordability threshold.

In another embodiment, the method further includes responsive to receiving, by the server, a minimum offer increase threshold from a seller of the property; presenting, by the server, for display in a second region of the graphical user interface, a second interactive graphical component representing the at least one offer; wherein the second interactive graphical component includes an offer price associated with the at least one offer to purchase the property, a target maximum offer associated with the upper comparable suggested value, and the minimum offer increase threshold.

In another embodiment, the method further includes presenting, by the server, for display in a third region of the graphical user interface, a third interactive graphical component representing an offer zone; wherein the third interactive graphical component includes a third affordability threshold marker to represent at least the affordability threshold; and wherein the third interactive graphical component includes an offer zone marker to represent at least one of the lower comparable suggested value and the upper comparable suggested value.

In another embodiment, the lower comparable suggested value is based at least in part on a first percentage less than the comparable suggested value; and the upper comparable suggested value is based at least in part on a second percentage greater than the comparable suggested value.

In another embodiment, the method further includes responsive to receiving, by the server, an updated offer to purchase the property: applying, by the server, the model to an updated plurality of property inputs and the updated plurality of offer inputs to output an updated offer affordability threshold; presenting, by the server, for display an updated fifth polygon in a position of the fifth polygon to represent the updated offer and a fourth affordability threshold marker in the position of the second threshold marker to represent the updated offer affordability threshold; and presenting, by the server, for display a notification on a second user device, wherein the notification is associated with the updated offer to purchase the property.

In another embodiment, the updated offer to purchase the property is higher than the offer to purchase the property and exceeds the minimum offer increase threshold above the at least one offer.

According to another implementation, the present disclosure relates to a system including a first user device, configured to display a graphical user interface; a second user device, configured to transmit at least one offer to purchase the property to a server; and the server. The server is configured to communicate with the first user device and the second user device; receive the at least one offer to purchase a purchase the property; apply a model configured to value the at least one offer by inputting a plurality of offer inputs and outputting a point value based on the plurality of offer inputs; present for display in a region of the graphical user interface, an interactive graphical component representing the at least one offer to purchase the property, wherein the interactive graphical component includes, for the at least one offer, a first polygon extending from an axis to represent a net offer price and a second polygon extending from the axis to represent the point value; receive an updated offer associated with the at least one offer to purchase the property; apply the model to an updated plurality of offer inputs to output an updated point value; present for display a revised graphical user interface having a revised interactive graphical component to include a first revised polygon representing the updated point value in a position of the second polygon representing the point value for the updated offer.

In some embodiments, the server is further configured to present for display in a second region of the graphical user interface, a second interactive graphical component representing the at least one offer to purchase the property; wherein the second interactive graphical component includes an offeror associated with the at least one offer to purchase the property; and wherein the second interactive graphical component displays the plurality of offer inputs associated with the at least one offer to purchase the property.

In another embodiment, the server is further configured to present for display in a third region of the graphical user interface, a third interactive graphical component representing an offeror's investment and the point value; wherein both the offeror's investment and the point value are associated with the at least one offer to purchase the property; wherein the offeror's investment is displayed graphically on a third polygon extending from a second axis to represent the offeror's investment in the at least one offer to purchase the property; and wherein the point value is displayed graphically on a fourth polygon extending from the second axis to represent the point value.

In another embodiment, the server is further configured to responsive to receiving, by the server, an interaction with the interactive graphical component, wherein the interactive graphical component is configured to receive a user interaction; and present for display at least one of the plurality of offer inputs associated with the at least one offer to purchase the property.

In another embodiment, the server is further configured to present for display a receipt notification on the first user device; wherein the receipt notification is associated with the updated offer to purchase the property.

In another embodiment, the plurality of offer inputs includes at least one of an offer price, a percent down payment, a days to close on escrow, a whether the at least one offer is contingent on a sale of another house, and a contingency time period.

In another embodiment, the second user device is configured to display a second graphical user interface.

In another embodiment, the server is further configured to present for display a notification on the second user device upon receiving an indication from the first user device that the at least one offer to purchase the property is accepted.

These and other features, together with the organization and manner of operation thereof, will become apparent from the following detailed description when taken in conjunction with the accompanying drawings.

It is to be understood that both the foregoing general description and the following detailed description are exemplary and explanatory and are intended to provide further explanation of the disclosure as claimed.

### BRIEF DESCRIPTION OF THE DRAWINGS

FIG. 1A is a block diagram of a virtual marketspace system including a buyer device, a seller device, and a smart negotiation system (including a smart pricing strategy and smart offer analytics), according to an embodiment.

FIG. 1B is a block diagram illustrating an example computing system suitable for use in the example embodiments described herein, according to an embodiment.

FIG. 2 is a flowchart for a method of generating and updating a point value for an offer to purchase a property, according to an embodiment.

FIG. 3 is a flowchart for a method of valuing a property and generating an affordability threshold for a buyer, according to an embodiment.

FIG. 4A. is a user interface on a buyer's device executing the smart negotiation system of FIG. 1A, according to an embodiment.

FIG. 4B is a user interface on a buyer's device executing the smart negotiation system of FIG. 1A, according to an embodiment.

FIG. 5A is a user interface on a seller's device executing the smart negotiation system of FIG. 1A, according to an embodiment.

FIG. 5B is a user interface on a seller's device executing the smart negotiation system of FIG. 1A, according to an embodiment.

FIG. 5C is a user interface on a seller's device executing the smart negotiation system of FIG. 1A, according to an embodiment.

FIG. 6 is a user interface of a user device executing the smart negotiation system of FIG. 1A, according to an embodiment.

FIG. 7 is a user interface of a user device executing the smart negotiation system of FIG. 1A, according to an embodiment.

FIG. 8 is a user interface of a user device executing the smart negotiation system of FIG. 1A, according to an embodiment.

FIG. 9 is a user interface of a user device executing the smart negotiation system of FIG. 1A, according to an embodiment.

FIG. 10 is a user interface of a user device executing the smart negotiation system of FIG. 1A, according to an embodiment.

FIG. 11 is a user interface of a user device executing the smart negotiation system of FIG. 1A, according to an embodiment.

FIG. 12 is a user interface of a user device executing the smart negotiation system of FIG. 1A, according to an embodiment.

FIG. 13 is a user interface of a user device executing the smart negotiation system of FIG. 1A, according to an embodiment.

FIG. 14 is a user interface of a user device executing the smart negotiation system of FIG. 1A, according to an embodiment.

It will be recognized that the figures are schematic representations for purposes of illustration. The figures are provided for the purpose of illustrating one or more embodiments with the explicit understanding that they will not be used to limit the scope or the meaning of the claims.

### DETAILED DESCRIPTION

Referring generally to the figures, the systems and methods presented relate generally to an interactive virtual marketspace system with systems and models for assisting buyers and sellers to more efficiently make favorable transactions in a real-time environment at a faster pace and more efficiently than in previous methods. The interactive virtual marketspace may be accessed through any user's device and is dynamically updated in real time as changes in the marketspace take place.

A buyer's device may present an interactive dashboard. The virtual marketspace system includes an affordability pricing system (i.e., Smart Pricing Strategy) to help buyers determine the most competitive offer in relation to their finances, the value of the property, the seller's asking price, and various other inputs. The pricing modeling system may be executed with artificial intelligence (“AI”) or machine learning to determine the buyer's affordability range and present this range in relation to the determined comparable values and asking price of the property. This affordability pricing modeling system may be used for a plurality of buyers to output unique pricing recommendations and ranges for each individual buyer within the plurality of buyers.

The virtual marketspace system may also provide sellers, on their devices, with an interactive dashboard similar to or distinct from that of the buyer's. The virtual marketspace system includes an offer comparison system (i.e., Smart Offer Analytics) to help sellers determine the most competitive offer in relation to all offers, beyond simply comparing the net offer price. In some embodiments, the offer comparison system is executed with AI or machine learning to determine which offer is most competitive for a seller to accept. The offer comparison system may output recommendations and interactive data to the seller's dashboard to quickly and effectively communicate to the seller a comparison of the offers, faster than traditional methods of displaying information associated with the offer (e.g., through paper offers and tables of offer terms). For example, the offer comparison system may analyze a plurality of offer inputs to determine a single offer point value. This point value may be used (and displayed to the seller) to efficiently compare a plurality of distinct and unique offers. In many embodiments, the offer comparison system updates in real time as new offers and updated offers are presented to the seller. This allows a user to monitor the status of the pending property sale without an agent filtering the results, and in doing so allows the seller to be more in control of the sale of the property than in traditional methods which resulted in extensive workflow, communication, paperwork, and forms for each offer. Instead, the seller may be presented, on a user device, with the point value to immediately compare offers.

In addition, the virtual marketspace system includes a market comparison system (i.e., Market Pricing Strategy) to compare recently sold properties to help sellers determine the most competitive sale price in relation to the current market. Sellers can set the start and date of offer acceptances, as well as the minimum offer price and the minimum offer price increases they are willing to accept. In some embodiments, the market comparison system is executed with AI or machine learning to determine the seller's property value range and most competitive price point for a seller to propose in the sale.

In some embodiments, the seller may want to use an agent to assist in the sale of the property. In such embodiments, the seller may give access to the seller's dashboard to an agent to navigate the negotiation on behalf of the seller. In such embodiments, the agent performs the functions of the seller's dashboard, while the seller's dashboard become dormant with no control. The seller receives notifications of the negotiation activities and monitors their sale. In other embodiments, the agent may have their own unique dashboard to actively monitor all sales associated with that agent. The agent's dashboard may display the single offer point value of multiple offers to help the agent quickly determine the best offers for a property. Likewise, an agent may compare offer point values across different properties to quickly and efficiently determine which properties are more desirable to the seller. In a similar vein, through the use of comparing point values across multiple properties, an agent may determine desirable locations, property features, etc. In some embodiments, the seller may also view point values of offers across various properties.

The present disclosure can also provide improvements to traditional property transaction methods by allowing for real-time communications regarding pending offers and counter offers. For example, in traditional property transactions, multiple offers are provided to the seller from a plurality of buyers for a predetermined time. Upon the conclusion of that predetermined time, the offers are compared by the seller's agent, and the highest offer is presented to the seller. In some situations, a seller may wish to extend the bid time to selected offerors to allow for improved offers based on the highest offer. This extends the time it takes to complete the transaction and creates friction to omitted buyers unaware of their position in the list of offers until the end of the bidding period. In some embodiments of the present disclosure, the negotiation and bidding process happens in real time, allowing buyers to know exactly where they stand in the list of bidders and allows them to immediately update their offer based on the output of the affordability pricing modeling system. For example, a buyer may receive a real-time (or nearly real-time) notification from the virtual marketspace system that a higher offer was presented to the seller. The interactive notification may allow for the buyer to update their offer by a minimum amount (as determined by the seller) to outbid the better offer. Alternatively, the buyer may choose to cancel their offer upon the notification of the higher offer. This accelerates the transaction process by allowing buyers to update offers prior to the ending of the bid period.

The affordability pricing system, offer comparison system, and market comparison system make this process possible and efficient. Because offers to buy property often consist of multiple terms and factors (e.g., closing time, down payment amount, contingency on selling a house, etc.), allowing buyers to modify their offers in real time to outbid each other in a traditional property transaction would result in a time-consuming and inefficient process as each offer would need to be communicated to each party and analyzed to determine its preferability to other offers. However, the offer comparison system allows this novel virtual marketspace system to function in real time, as a seller can immediately compare offers at any time without needing to sift through the traditional paperwork and information related to many multiple offers. In addition, the seller may adjust the offer comparison system to dictate which offer terms are most and least important, thus individualizing the point value to the seller's preferences. In the embodiment in which a user (e.g., the seller, the seller's agent, the buyer, or the buyer's agent) may view the point value various offers across various properties, the user may adjust all point values to be calculated based on a single set of offer comparison criteria, thus normalizing all offers to the same criteria. Likewise, a buyer is empowered to update a bid for the property in real time as the pricing affordability system immediately provides the buyer with an indication of how competitive the buyer's offer is compared to other offers all while keeping at top of mind the range in which the buyer may offer. Again, this novel virtual marketspace system is only possible because of the efficient display and presentation of the most relevant information as generated by the virtual marketspace system on the buyer's dashboard as presented on the buyer's device.

It should be appreciated that the virtual marketspace system and constituent systems are updated in real time without the need for user interaction. As such, providing yet another technical solution to a traditional problem: notifying buyers when their affordability range increases, or their offer point value increases based on changing circumstances. For example, an affordability pricing modeling system may monitor a buyer's bank statements and current interest rates to determine possible loan amounts or possible down payment options. Upon receiving an indication of an increase in available funds, the affordability pricing modeling system may notify the buyer that the affordability range has increased and allow the user to increase the buyer's offer if desired. This provides a particularly poignant solution to situations in which interest rates are quickly rising or crashing because a buyer is notified immediately upon the changing circumstances. In some instances, a buyer may be automatically notified if the buyer's offer becomes higher than the buyer's affordability threshold due to changing micro- or macroeconomic conditions as collected and analyzed by the affordability pricing modeling system.

The virtual marketspace system may rid the real estate market of pocket listings, exclusive listings, in-network buyers, and other forms of double agency.

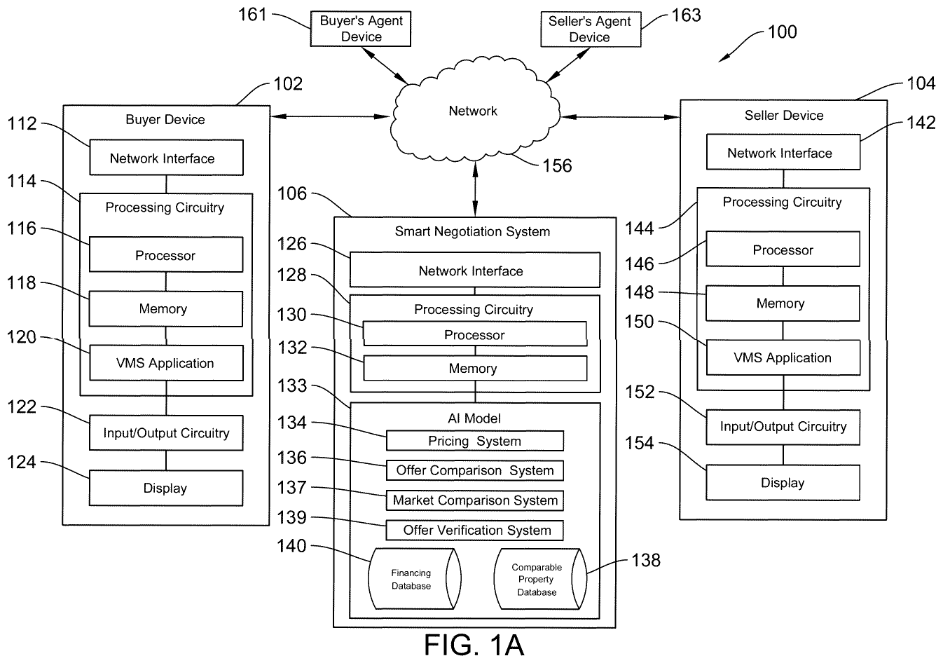

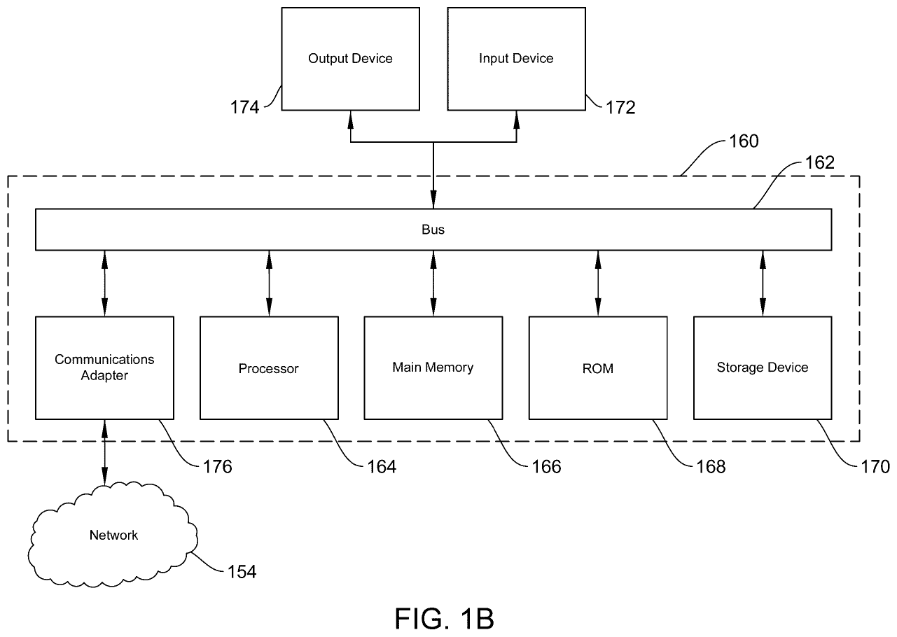

FIG. 1A illustrates block diagram of interactive virtual marketspace system (“VMS”) 100, according to some embodiments. The interactive VMS 100 includes a buyer device 102, a seller device 104, a buyer's agent device 161, a seller's agent device 163, and a smart negotiation system 106. The interactive VMS may also include additional devices, such as a financial institution device, transaction coordinator device, etc. In some embodiments, the buyer device 102, the seller device 104, the buyer's agent device 161, the seller's agent device 163, and the smart negotiation system 106 are directly communicably coupled. In some embodiments, the components of VMS 100 maybe communicatively and operatively coupled to each other over a network such as network 156 that permits the direct or indirect exchange of data, values, instructions, messages, and the like (represented by double-headed arrows in FIG. 1A). The network 156 may include one or more cellular networks, the Internet, Wi-Fi, a proprietary provider network, proprietary retailer service provider network, and/or any other kind of wireless or wired network.

Each device or system of VMS 100 may include one or more network interfaces, processing circuitry, processors, memories, user interfaces, and programmable applications. The memory may store any number of programming logic, that when executed by the processor, control the operation of the corresponding computing system or device. In some embodiments, the memory may also store databases of varying information. For example, memory 132 may store programming logic that when executed by processor 128 within processing circuit 128 of smart negotiation system 106, causes pricing system 134 to update an affordability range and affordability threshold for a buyer upon receiving a communication from the buyer device. In some embodiments, the network interfaces 112, 126, 142 may facilitate or otherwise allow communication between the various devices and computing systems of VMS 100 (e.g., buyer device 102, seller device 104, and smart negotiation system 106). While in some embodiments the various components of VMS 100 are implemented in hardware (e.g., circuitry), in other embodiments the various components of VMS 100 are implement in software (e.g., executable code), or any combination thereof. Devices and components in FIG. 1A can be added, deleted, integrated, separated, and/or rearranged in various embodiments of the disclosure.

Buyer device 102 may be any suitable user device, including a cellular device, a computing device, tablet computer, desktop computer, laptop computer, a smart watch, augmented reality glasses, etc. The buyer device 102 is often associated with a potential buyer of a property and is used by the potential buyer to view the outputs of the pricing system 134 and offer comparison system 136 of the smart negotiation system 106. Additionally, the buyer device 102 is used to interact with the VMS application 120 to generate an offer to purchase the property, update the offer to purchase the property, contact the seller or seller's agent, view the property details, and adjust threshold pricing inputs to affect the pricing system 134 outputs.

The buyer device 102 may include a network interface 112, a processing circuitry 114 containing a processor 116, a memory 118, a VMS application 120, an input/output circuitry, and a display. The network interface 112 is used to communicate with other computing and communication devices (e.g., the seller device 104 and the smart negotiation system 106) through the network 156. The network interface 112 may include program logic to establish a communication connection between the buyer device 102 and the network 156. In some embodiments, the network interface 112 includes one or more of a wired network transceiver or wireless network transceiver (e.g., cellular modem, Bluetooth, Wi-Fi, etc.). While in some embodiments the network interface 112 is composed of software (e.g., programming logic), it is understood that the network interface 112 may also include hardware (e.g., circuitry) to establish and support communication over multiple channels of data communication. Additionally, the network interface 112 may include security protocols to encrypt and protect potentially sensitive data such as credit card information, social security numbers, personally identifiable information, birthdates, financial information, etc. In some embodiments, network interface 112 is configured to obfuscate potentially sensitive information from another device not having authentication. For example, a buyer may wish to obfuscate from the seller the buyer's financial information (e.g., bank statements) as stored in the memory of the processing circuitry 114 when the buyer is making an offer to purchase the property. However, upon the seller selecting the buyer's offer to purchase the property, the seller may wish to view the buyer's financial information to verify the buyer's ability to pay the purchase price. In such embodiments, a buyer may grant the seller authentication to view the previously hidden data. This may be done in various manners and methods including, for example, adjusting security filters. In some embodiments, the buyer device communicates directly to the seller device through network interfaces 112, 142 and network 156. Such examples include messaging the seller (or seller's agent) directly to discuss the buyer's offer, the property, or the pending transaction generally. However, in some embodiments, all communication between the buyer device 102 and seller device 104 is transmitted through the smart negotiation system 106 by way of the network interfaces 112, 142, 126 and network 156. By transmitting all communications between buyer and seller through the smart negotiation system 106, the VMS 100 may be able to maintain security of the personal information of each party. Contact information and any other personally identifiable information may be hidden by the smart negotiation system 106 while still allowing free communication between the parties.

The processing circuitry 114 includes a processor 116, a memory 118, and a VMS application 120. Various memory 118 embodiments exist, including RAM, ROM, flash memory, hard disk storage, etc. Memory 118 is used to store data and computer code for executing the various processes disclosed. Additionally, the memory 118 may include transient volatile memory, non-volatile memory, and non-transitory computer storage media. In some embodiments, the memory 118 includes database components, object code components, script components, or any other type of information structure for supporting the various activities and information structures described herein. In many embodiments, the processor 116 is communicatively coupled to the memory 118. In many embodiments, the VMS application 120 is communicably coupled to the memory 118. The processor 116 may be implemented as one or more application specific integrated circuits (ASICs), field programmable gate arrays (FPGAs), a group of processing components, or other suitable electronic processing components. As such, the buyer device 102 is configured to run a variety of application programs and store associated data (e.g., buyer financial and personal information). One such application may be the VMS application 120.

In some embodiments, buyer information (e.g., financial information, personal information, past purchases, etc.) may be stored in memory 118. Personal user information may include the buyer's name, age, gender, address, education, occupation, customer preferences, such as notification preferences, security preferences, etc., and authentication information, such as customer passwords, biometric data for the customer, geographic information, etc. In some embodiments, the information stored in the memory is protected or otherwise encrypted, only accessible through the use of a password or other authentication protocol (e.g., biometrics).

The VMS application 120 may be downloaded from the smart negotiation system 106 prior to its usage (e.g., from the App Store® or Google Play Store®), hard coded into the memory 118, or be a network-based (e.g., web-based) application (e.g., hosted on the smart negotiation system 106) which may be executed remotely from the buyer device 102. The buyer device 102 may include software and/or hardware capable of implementing a network-based or web-based application. For example, in some instances, the VMS application 120 includes software such as HTML, XML, WML, SGML, PHP (Hypertext Preprocessor), CGI, and like languages.

In certain embodiments, the VMS application 120 is hard coded into the memory. In these embodiments, the buyer device may execute the smart negotiation system 106 locally on the device. In this embodiment, the buyer device may execute the smart negotiation system 106 locally on the buyer device without connecting to the smart negotiation system 106 over the network. In other embodiments, the VMS application 120 is an interface which facilitates the integration of the smart negotiation system 106 with the buyer device. In certain embodiments, the VMS application 120 includes an application programming interface (API) and/or a software development kit (SDK) that facilitates the integration of other applications with the VMS application 120. For example, the VMS application 120 may be configured to interface with the smart negotiation system 106 to pull/push data to and from the memory 132, the pricing system 134, the offer comparison system 136, the market comparison system 137, offer verification system 139, the comparable property database 138, and the financing database 140.

The input/output circuitry 122 receives and provides communications to the buyer associated with the buyer device 102. The input/output circuitry 122 is configured to display images on the user device display 124 and otherwise communicate (e.g., aurally, tactilely, etc.) information to the user. The input/output circuitry 122 is configured to receive communications from the user associated with buyer device 102 to exchange data, values, messages, etc. between the components of buyer device 102. For example, the buyer may utilize the input/output circuitry 122 to input personal and financial information to either be stored in the memory 118 or otherwise be transmitted by the network interface to the seller device 104 or the smart negotiation system 106. Likewise, the output circuitry may output information to the buyer as received through the network interface from the seller device 104 or smart negotiation system 106.

The input/output circuitry 122 includes input/output ports and/or uses an interconnect bus (not shown) to communicate with the display 124, speakers, a haptic engine, input devices (e.g., alphanumeric keyboard, mouse, trackball, etc.), microphone, touch screen, biometric device, camera, augmented/virtual reality headset, etc. Through the input/output circuitry 122, the buyer interacts with the different components of the buyer device 102 and any applications housed on the device (or otherwise accessed by the internet). The buyer's agent device 161 is configured substantially similarly to the buyer device 102.

Referring still to FIG. 1A, seller device 104 may be any suitable user device, including a cellular device, a computing device, tablet computer, desktop computer, laptop computer, a smart watch, augmented reality glasses, etc. The seller device 104 is often associated with a seller of the property and is used by the seller to view the outputs of the pricing system 134, market comparison system 137, and offer comparison system 136 of the smart negotiation system 106. Additionally, the seller device 104 is used to interact with the VMS application 120 to generate a listing of the property to sale, update the listing to sell the property, contact the buyer or buyer's agent, view the property details, adjust threshold pricing inputs to affect the pricing system 134 outputs, adjust offer comparison inputs to personalize the offer comparison model, accept offers to purchase the property, make counter offers to buyers, etc.

The seller device 104 may include a network interface 142, a processing circuitry 144 containing a processor 146, a memory 148, and a VMS application 150, an input/output circuitry 152, and a display 154. The network interface 142 is used to communicate with other computing and communication devices (e.g., the buyer device 102 and the smart negotiation system 106) through the network 156. The network interface 142 may include program logic to establish a communication connection between the seller device 104 and the network 156. In some embodiments, the network interface 142 includes one or more of a wired network transceiver or wireless network transceiver (e.g., cellular modem, Bluetooth, Wi-Fi, etc.). While in some embodiments the network interface 142 is composed of software (e.g., programming logic), it is understood that the network interface 142 may also include hardware (e.g., circuitry) to establish and support communication over multiple channels of data communication. Additionally, the network interface 142 may include security protocols to encrypt and protect potentially sensitive data such as credit card information, social security numbers, personally identifiable information, birthdates, financial information, electronic messages, etc. In some embodiments, network interface 142 is configured to obfuscate potentially sensitive information from another device without authentication. For example, a seller may wish to obfuscate from the buyer the seller's financial information (e.g., bank statements) as stored in the memory 148 of the processing circuitry 144 when the buyer is making an offer to purchase the property. Additionally, the seller may wish to obfuscate from a buyer the details of the any other offers. However, at times, the seller may wish to share the exact details of the various other offers to aid in transparency of the negotiation process. In such embodiments, a seller may grant the buyer authentication to view the previously hidden data (e.g., the other offers). This may be done in various manners and methods including, for example, adjusting security filters. In some embodiments, the seller device communicates directly to the buyer device through network interface 112, 142 and network 156. Such examples include messaging the buyer (or buyer's agent) directly to discuss the buyer's offer, the property, or the pending transaction generally. However, in some embodiments, all communication between the buyer device 102 and seller device 104 is transmitted through the smart negotiation system 106 by way of the network interface 112, 142, 126 and network 156. By transmitting all communications between buyer and seller through the smart negotiation system 106, the VMS 100 is able to maintain security of the personal information of each party. Contact information and any other personally identifiable information may be hidden by the smart negotiation system 106 while still allowing free communication between the parties.

The processing circuitry 144 includes a processor 146, a memory 148, and a VMS application 150. Various memory 148 embodiments exist, including RAM, ROM, flash memory, hard disk storage, etc. Memory 148 is used to store data and computer code for executing the various processes disclosed. Additionally, the memory 148 may include transient volatile memory, non-volatile memory, and non-transitory computer storage media. In some embodiments, the memory 148 includes database components, object code components, script components, or any other type of information structure for supporting the various activities and information structures described herein. In many embodiments, the processor 146 is communicatively coupled to the memory 148. In many embodiments, the VMS application 150 is communicably coupled to the memory 148. The processor 146 may be implemented as one or more application specific integrated circuits (ASICs), field programmable gate arrays (FPGAs), a group of processing components, or other suitable electronic processing components. As such, the seller device 104 is configured to run a variety of application programs and store associated data (e.g., buyer financial and personal information). One such application may be the VMS application 150.

In some embodiments, seller information (e.g., financial information, personal information, past transactions, etc.) may be stored in memory 148. Personal user information may include the seller's name, age, gender, address, education, occupation, customer preferences, such as notification preferences, security preferences, authentication information, such as customer passwords, biometric data for the customer, geographic information, etc. In some embodiments, the information stored in the memory 148 is protected or otherwise encrypted, only accessible through the use of a password or other authentication protocol (e.g., biometrics).

The VMS application 150 may be downloaded from the smart negotiation system 106 prior to its usage (e.g., from the App Store® or Google Play Store®), hard coded into the memory 148, or be a network-based (e.g., web-based) application (e.g., hosted on the smart negotiation system 106) which may be executed remotely from the seller device 104. The seller device 104 may include software and/or hardware capable of implementing a network-based or web-based application. For example, in some instances, the VMS application 150 includes software such as HTML, XML, WML, SGML, PHP (Hypertext Preprocessor), CGI, and like languages.

In certain embodiments, the VMS application 150 is hard coded into the memory. In these embodiments, the seller device may execute the smart negotiation system 106 locally on the device. In this embodiment, the buyer device may execute the smart negotiation system 106 locally on the seller device without connecting to the smart negotiation system 106 over the network 156. In other embodiments, the VMS application 150 is an interface which facilitates the integration of the smart negotiation system 106 with the seller device 104. In certain embodiments, the VMS application 150 includes an application programming interface (API) and/or a software development kit (SDK) that facilitates the integration of other applications with the VMS application 150. For example, the VMS application 150 may be configured to interface with the smart negotiation system 106 to pull/push data to and from the memory 132, the pricing system 134, the offer comparison system 136, the comparable property database 138, and the financing database 140.

The input/output circuitry 152 receives and provides communications to the seller associated with the seller device 104. The input/output circuitry 152 is configured to display images on the user device display 154 and otherwise communicate (e.g., aurally, tactilely, etc.) information to the user. The input/output circuitry 152 is configured to receive communications from the user associated with seller device 104 to exchange data, values, messages, etc. between the components of seller device 104. For example, the seller may utilize the input/output circuitry 152 to input personal and financial information to either be stored in the memory 148 or otherwise be transmitted by the network interface to the seller device 104 or the smart negotiation system 106. Likewise, the output circuitry may output information to the seller as received through the network interface 142 from the buyer device 102 or smart negotiation system 106.

The input/output circuitry 152 includes input/output ports and/or uses an interconnect bus (not shown) to communicate with the display 124, speakers, a haptic engine, input devices (e.g., alphanumeric keyboard, mouse, trackball, etc.), microphone, touch screen, biometric device, camera, augmented/virtual reality headset, etc. As used herein, virtual reality, augmented reality, and mixed reality may each be used interchangeably yet refer to any kind of extended reality, including virtual reality, augmented reality, and mixed reality. Through the input/output circuitry 152, the seller interacts with the different components of the seller device 104 and any applications housed on the device (or otherwise accessed by the internet). The seller's agent device 163 may be configured substantially similar to the seller device 104.

Smart negotiation system 106 is a component of the interactive VMS 100 as disclosed herein. Smart negotiation system 106 may take many forms, including, but not limited to, a server, distributed processing cluster, cloud processing system, locally housed application, or any other computing device. In some embodiments, smart negotiation system 106 is includes software configured to execute programming logic or otherwise execute a computer program/script. In some embodiments, smart negotiation system 106 includes hardware. Hardware of smart negotiation system 106 may include processing circuitry 128, a processor 130, memory 132, etc. In yet other embodiments, smart negotiation system 106 may include both software and hardware to execute the smart negotiation systems.

In an embodiment as shown in FIG. 1A, the smart negotiation system 106 includes a network interface 126, a processing circuitry 128 containing a processor 130, a memory 132, a pricing system 134 (i.e., smart pricing strategy), an offer comparison system 136 (i.e., smart offer analytics), a market comparison system 137 (i.e., market pricing strategy), an offer verification system 139, a comparable property database 138, and a financing database 140. The network interface 126 is used to communicate with other computing and communication devices (e.g., the buyer device 102 and the seller device 104) through the network 156. The network interface 126 may include program logic to establish a communication connection between the smart negotiation system 106 and the network 156. In some embodiments, the network interface 126 includes one or more of a wired network transceiver or wireless network transceiver (e.g., cellular modem, Bluetooth, Wi-Fi, etc.). While in some embodiments the network interface 126 is composed of software (e.g., programming logic), it is understood that the network interface 126 may also include hardware (e.g., circuitry) to establish and support communication over multiple channels of data communication. Additionally, the network interface 142 may include security protocols to encrypt and protect potentially sensitive data such as credit card information, social security numbers, personally identifiable information, birthdates, financial information, electronic messages, etc. In some embodiments, network interface 126 is configured to obfuscate potentially sensitive information from devices without authentication. For example, the smart negotiation system 106 may store in memory 132 all listings of properties, all past transactions, offers to purchase, and all personal information of all users of smart negotiation system 106. Upon establishing a connection to buyer device through network 156, the smart negotiation system 106 may obfuscate from the buyer any data/information not directly applicable to the buyer. For example, the buyer may only be able to access, with an authentication password (or other authentication technique, e.g., biometrics), the buyer's personal information, the buyer's affordability threshold information, the buyer's offers, saved listings, messages with other users notifications from the seller, etc. However, smart negotiation system 106 may obfuscate a seller's personal information, a seller's messages, the seller's offer comparisons, the seller's saved listings, etc. This obfuscation may be executed by the network interface 126, the processing circuitry 128, or any other component within smart negotiation system 106.

In some embodiments, the smart negotiation system 106 may communicate directly to the buyer device through network interface 126, 112 and network 156. Examples of communications sent from smart negotiation system 106 to buyer device 102 include real-time notifications of a seller's counteroffer, a higher offer was received, their offer was rejected, an accepted offer, updated affordability threshold, and messages from the seller device 104. Additionally, the smart negotiation system 106 may be configured to communicate the outputs of the AI model 133 pricing system 134 (e.g., an affordability threshold) to buyer device 102. The smart negotiation system 106 may also be configured to communicate the outputs of the offer comparison system 136 (e.g., an offer's point value) to the buyer device 102. In other embodiments, the smart negotiation system 106 may be configured to communicate to the buyer device information/data housed in the comparable property database 138 and the financing database 140. The smart negotiation system 106 may be configured to communicate with the seller device 104 in substantially the same manner as the buyer device 102.

The processing circuitry 128 includes a processor 130, and a memory 132. Various memory 132 embodiments exist, including RAM, ROM, flash memory, hard disk storage, etc. Memory 132 is used to store data and computer code for executing the various processes disclosed. Additionally, the memory 132 may include transient volatile memory, non-volatile memory, and non-transitory computer storage media. In some embodiments, the memory 132 includes database components, object code components, script components, or any other type of information structure for supporting the various activities and information structures described herein. In many embodiments, the processor 128 is communicatively coupled to the memory 132. The processor 130 may be implemented as one or more application specific integrated circuits (ASICs), field programmable gate arrays (FPGAs), a group of processing components, or other suitable electronic processing components. As such, the smart negotiation system 106 is configured to run a variety of application programs and store associated data (e.g., buyer financial and personal information, pending transactions, seller information, comparable housing statistics and pricing, financial lending information, etc.).

In some embodiments, buyer and seller information (e.g., financial information, personal information, past transactions, etc.) may be stored in memory 132. Personal user information may include the buyer's/seller's name, age, gender, address, education, occupation, customer preferences, such as notification preferences, security preferences, authentication information, such as customer passwords, biometric data for the customer, geographic information, etc. In some embodiments, the information stored in the memory 132 is protected or otherwise encrypted, only accessible through the use of a password or other authentication protocol (e.g., biometrics).

The smart negotiation system 106 also includes an AI model 133. The AI model 133 may include a pricing system 134, an offer comparison system 136, a market comparison system 137, an offer verification system 139, a comparable property database 138, and a financing database 140. The AI model 133 may also include additional systems, such as a form-to-contract system for automatically generating transactional contracts from the results of the smart negotiation system. The AI model 133 may be configured to receive inputs from buyer device 102 to determine an affordability threshold for the buyer. In some embodiments, the pricing system 134 of the AI model 133 is used to aggregate data received from the buyer device 102, information from the financing database 140, information from the comparable property database 138, outputs of the offer comparison system 136, and information received from the seller device 104. AI model 133 then executes pricing system 134 to determine an affordability threshold for the buyer.

The AI model 133 may also be configured to receive inputs from the seller device 104 to compare offers to purchase the property. In some embodiments, the offer comparison system 136 of the AI model 133 is used to aggregate data received from the buyer device 102, information from the financing database 140, information from the comparable property database 138, outputs of the pricing system 134, and information received from the buyer device 102. AI model 133 then executes the offer comparison system 136 to compare a plurality of offers in real time, as described in greater detail herein.

The AI model 133 may also be configured to generate comparable suggested values for the list property through executing the market comparison system 137. The market comparison system 137 may be configured to aggregate data received from the comparable property database 138 and seller inputs received from seller device 104. AI model 133 then executes the market comparison system 137 to determine a comparable suggested value, a higher comparable suggested value, and a lower comparable suggested value for the property for sale to aid the seller in choosing a competitive listing price.

FIG. 1B illustrates a depiction of a computing system 160 that can be used, for example, to implement the interactive VMS 100, seller device 104, seller device 104, smart negotiation system 106, and/or various other example systems described in the present disclosure, according to some embodiments. The computing system 160 includes a bus 162 or other communication component for communicating information and a processor 164 coupled to the bus 162 for processing information. The computing system 160 also includes main memory 166, such as a random-access memory (RAM) or other dynamic storage device, coupled to the bus 162 for storing information, and instructions to be executed by the processor 164. Main memory 166 can also be used for storing position information, temporary variables, or other intermediate information during execution of instructions by the processor 164. The computing system 160 may further include a read only memory (ROM) 168 or other static storage device coupled to the bus 162 for storing static information and instructions for the processor 164. A storage device 170, such as a solid-state device, magnetic disk or optical disk, is coupled to the bus 162 for persistently storing information and instructions.

The computing system 160 may be coupled via the bus 162 to a display 174, such as a liquid crystal display, or active-matrix display, for displaying information to a user. An input device 172, such as a keyboard including alphanumeric and other keys, may be coupled to the bus 162 for communicating information, and command selections to the processor 164. In another arrangement, the input device 172 has a touch screen display 174. The input device 172 can include any type of biometric sensor, a cursor control, such as a mouse, a trackball, or cursor direction keys, for communicating direction information and command selections to the processor 164 and for controlling cursor movement on the display 174.

In some arrangements, the computing system 160 may include a communications adapter 176, such as a networking adapter. Communications adapter 176 may be coupled to bus 162 and may be configured to enable communications with a computing or communications network 180 and/or other computing systems. In various illustrative arrangements, any type of networking configuration may be achieved using communications adapter 176, such as wired (e.g., via Ethernet), wireless (e.g., via Wi-Fi, Bluetooth, and so on), satellite (e.g., via GPS) pre-configured, ad-hoc, LAN, WAN, and so on.

According to various arrangements, the processes that effectuate illustrative arrangements that are described herein can be achieved by the computing system 160 in response to the processor 164 executing an arrangement of instructions contained in main memory 166. Such instructions can be read into main memory 166 from another computer-readable medium, such as the storage device 170. Execution of the arrangement of instructions contained in main memory 166 causes the computing system 160 to perform the illustrative processes described herein. One or more processors in a multi-processing arrangement may also be employed to execute the instructions contained in main memory 166. In alternative arrangements, hard-wired circuitry may be used in place of or in combination with software instructions to implement illustrative arrangements. Thus, arrangements are not limited to any specific combination of hardware circuitry and software.

Although an example processing system has been described in FIG. 1B, arrangements of the subject matter and the functional operations disclosed herein can be carried out using other types of digital electronic circuitry, or in computer software (e.g., application, blockchain, distributed ledger technology) embodied on a tangible medium, firmware, or hardware, including the structures disclosed in this application and their structural equivalents, or in combinations of one or more of them. Arrangements of the subject matter disclosed herein can be implemented as one or more computer programs, e.g., one or more subsystems of computer program instructions, encoded on one or more computer storage medium for execution by, or to control the operation of, a data processing apparatus. Alternatively, or in addition, the program instructions can be encoded on an artificially generated propagated signal, e.g., a machine generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

Although shown in the arrangements of FIG. 1B as singular, stand-alone devices, one of ordinary skill in the art will appreciate that, in some arrangements, the computing system 160 may comprise virtualized systems and/or system resources. For example, in some arrangements, the computing system 160 may be a virtual switch, virtual router, virtual host, virtual server, etc. In various arrangements, computing system 160 may share physical storage, hardware, and other resources with other virtual machines. In some arrangements, virtual resources of the network 180 (e.g., network 156 of FIG. 1A) may include cloud computing resources such that a virtual resource may rely on distributed processing across more than one physical processor, distributed memory, etc.

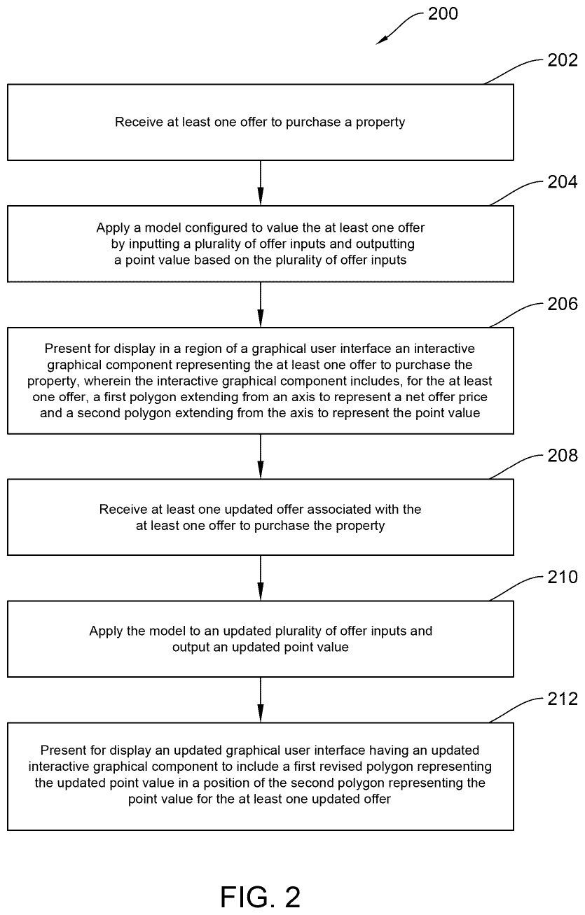

Referring now to FIG. 2, a flowchart for a method 200 of applying an AI model to a plurality of inputs to determine a point value for an offer to purchase a property. The system 100 can be configured to perform method 200. Furthermore, any computing device described herein can be configured to perform method 200. In some embodiments, method 200 is performed locally on the buyer device 102 of FIG. 1A, seller device 104, or seller device 104 of FIG. 1A, or the smart negotiation system 106 of FIG. 1A.

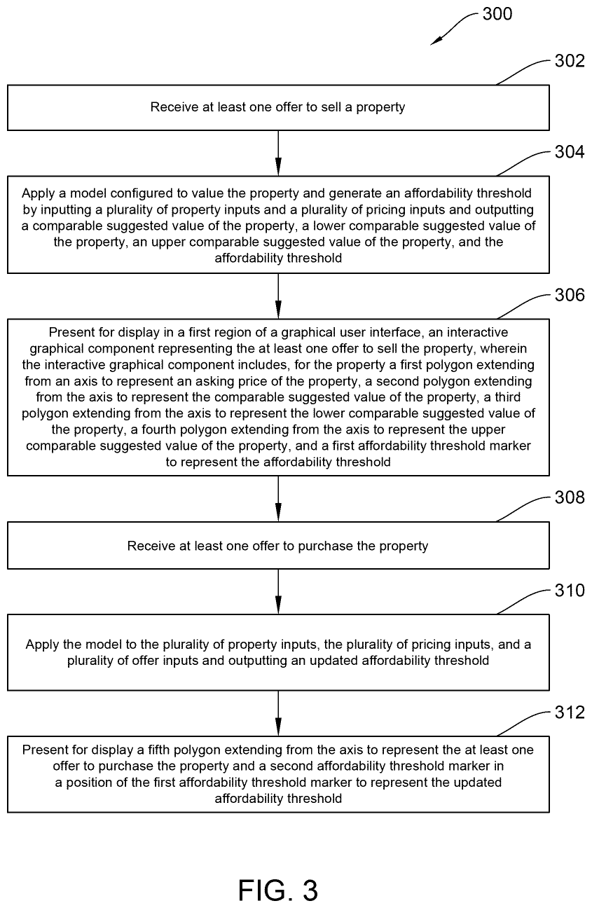

In broad overview of method 200, at step 202, one or more processing circuits receive an offer to purchase a property. At step 204, one or more processing circuits apply a model (e.g., an AI model) configured to value the at least one offer by inputting a plurality of offer inputs and outputting a point value based on the plurality of offer inputs. At step 206, one or more processing circuits present for display in a region of a graphical user interface an interactive graphical component representing the at least one offer to purchase the property, wherein the interactive graphical component includes, for the at least one offer, a first polygon extending from an axis to represent a net offer price and a second polygon extending from the axis to represent the point value. At step 208, one or more processing circuits receive at least one updated offer associated with the at least one offer to purchase the property. At step 210, one or more processing circuits apply the model (e.g., the AI model) to an updated plurality of offer inputs and output an updated point value. At step 212, one or more processing circuits present for display an updated graphical user interface having an updated interactive graphical component to include a first revised polygon representing the updated point value in a position of the second polygon representing the point value for the at least one updated offer. While an example method is shown in FIG. 2, it should be understood that additional, fewer, or different options may be performed in the method in view of particular circumstances. For example, in some embodiments, some or all of the operations of method 200 are performed by one or more processors executing on one or more computing devices, systems, or servers. In some embodiments, the steps of method 200 may be reordered or repeated. Combinations and variations of the operations and methods described herein are also included within the scope of the present disclosure (e.g., the incorporation of one or more steps of method 300 of FIG. 3).

In general, method 200 depicts a method of analyzing a buyer's offer to purchase a property, using an AI model to generate a point value (either a singular point value or multi-dimensional point value) to represent the offer. This point value is a representation of the offer that allows a seller or buyer to quickly and efficiently compare multiple offers in real-time as offers are made. The buyer updates the offer to improve it in comparison with other offers and the AI model dynamically executes again to generate an updated point value for the updated offer and thereafter display the updated point value to one or more of the buyer and seller.

Referring now to method 200 in more detail, at step 202, a smart negotiation system receives through a network, an offer to purchase a property. The property may be of any form, including, but not limited to real estate, intellectual, personal, etc. According to some embodiments, the smart negotiation system is an application stored and executed locally on a user device (e.g., a buyer's, seller's, or agent's device). Alternatively, the smart negotiation system may be stored and executed remote to the user device on a server or otherwise remote device configured to execute processing logic. A buyer may interact with a user device (e.g., the buyer's device) to input a plurality of offer inputs into the smart negotiation system through a variety of input devices including alphanumeric keyboard, a joystick, microphone, mouse, buttons, etc. These inputs may be inputted directly into the smart negotiation system or may be transmitted from a smart negotiation system application interface.

At step 204, the smart negotiation system applies a model (e.g., an AI model) configured to value the at least one offer by inputting a plurality of offer inputs and outputting a point value based on the plurality of offer inputs. The point value is a unique weighted point value to represent the buyer's offer to purchase the property. Offers to purchase property may include various inputs beyond a total offer price. For example, when purchasing real estate, offers to purchase property often include a percent down of the total offer, wherein the percent down is a percent of the total offer which the buyer provides without financing. Generally speaking, all things being equal, an offer with a higher percent down is a more competitive offer than a second offer with a lower percent down. This may be due to risks of financing falling through for a buyer with higher leverage. Additionally, offers to purchase real estate often include inspection periods, closing date, contingencies (e.g., selling another property, getting financing, etc.), earnest money amount, etc. Because of the multi-faceted characterization of an offer to purchase property, it is difficult to quickly and instantaneously compare offers. This is a benefit and solution provided by the point value as disclosed herein. The AI model collects the offer inputs as received by the smart negotiation system and applies different weights (either with default weights or by weights as dictated by the buyer or seller) to the various inputs to determine a point value to compare against the other offers' point values. In some embodiments, the point value may be a singular value.

In other embodiments, the AI model may collect/receive information from a database to use in the generation of a point value. For example, the AI model may collect data of offers from comparable properties to generate a point value in relation to all offers of comparable properties. This data of comparable properties may be stored in a database hosted in the AI model. Alternatively, the database may be hosted remote from the smart negotiation system or AI model. In such embodiments, the AI model may receive the comparable property data from the database by a network through a network interface.

As described herein, the AI model may use machine learning protocols to improve the accuracy of point values over time (e.g., learn a user's preferences when selecting offers and updating the algorithm or model to reflect those preferences).

The machine-learning architecture can be implemented utilizing a machine learning algorithm (e.g., a neural network, convolutional neural network, recurrent neural network, linear regression model, sparse vector machine, or any other algorithm known to a person of ordinary skill in the art). The machine-learning architecture can be communicably coupled to other machine-learning architectures (e.g., such as over a network). The machine-learning architecture can have an internal logging system that can be utilized to collect and/or store data (e.g., in an analysis database).

In some implementations, the machine-learning architecture can be executed on one or more processing circuits, such as those described below in detail with reference to FIGS. 1A-1B. The processing circuits can include a microprocessor, an application specific integrated circuit (ASIC), a field-programmable gate array (FPGA), etc., or combinations thereof. The memory can include, but is not limited to, electronic, optical, magnetic, or any other storage or transmission device capable of providing processor with program instructions. The instructions can include code from any suitable computer programming language. In some implementations, machine learning model can be trained utilizing a portion of a data set that is associated with a plurality of entities such that it can recognize one or more patterns in subsequent received data. The subsequent received data can in turn be utilized to generate an embedding vector based on the plurality of entities utilized to train the model.

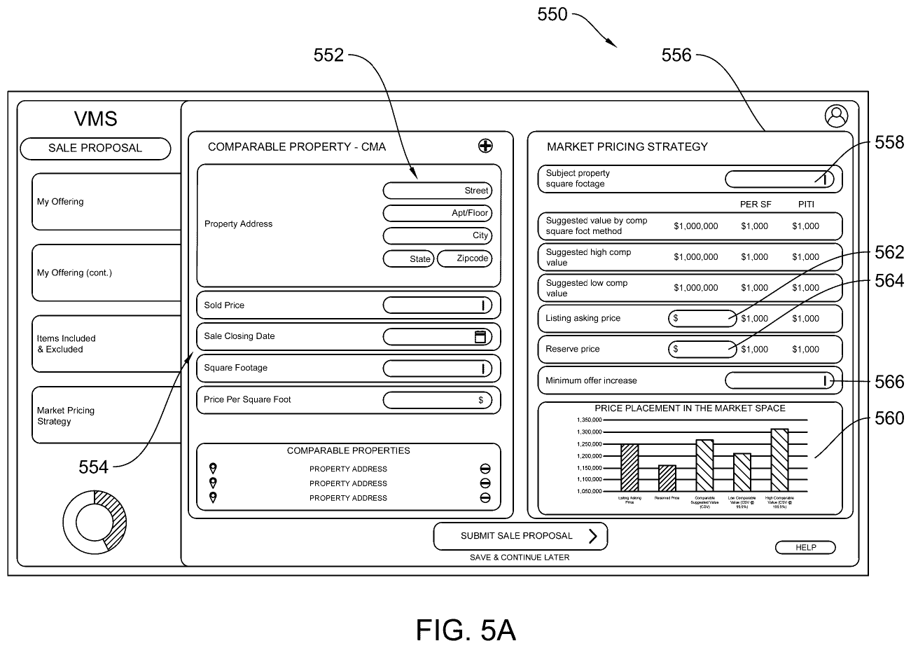

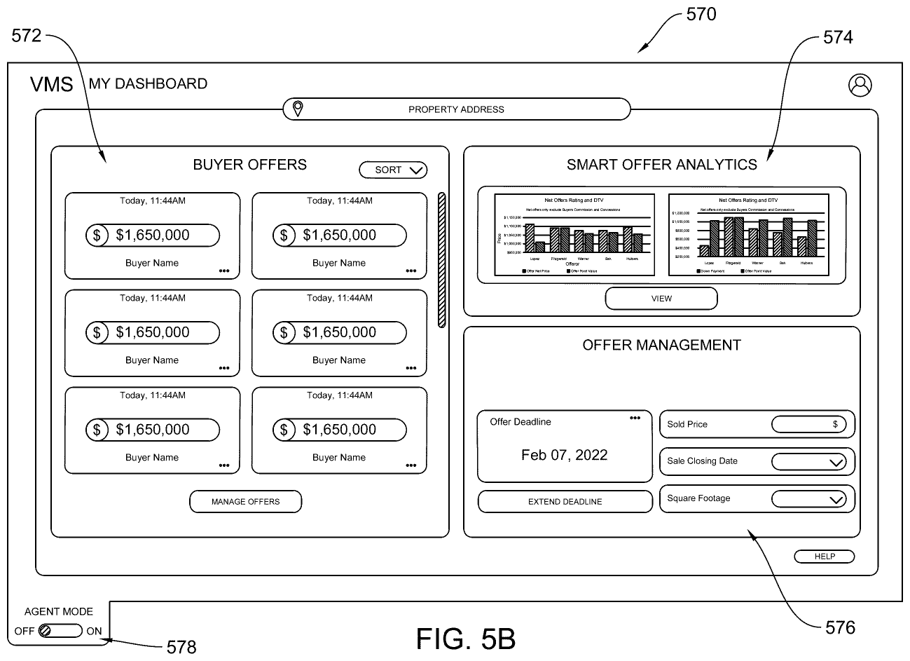

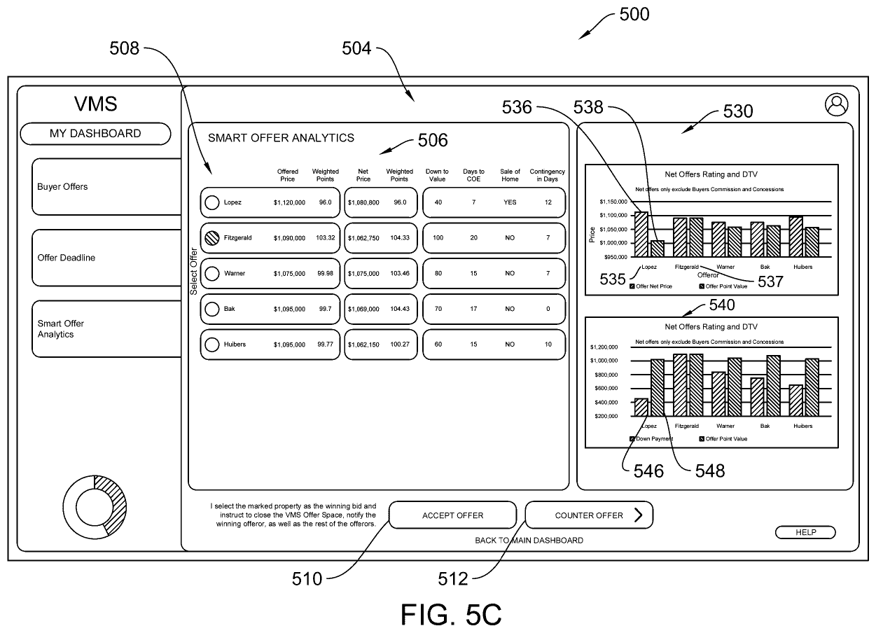

At step 206, the smart negotiation system presents for display in a region of a graphical user interface an interactive graphical component representing the at least one offer to purchase the property, wherein the interactive graphical component includes, for the at least one offer, a first polygon extending from an axis to represent a net offer price and a second polygon extending from the axis to represent the point value. In some embodiments, the point value is displayed relative to the net offer price or the offered percent down payment (or any other user-selected input of the offer). In some embodiments, the point value is displayed as a number. In other embodiments, the point value is displayed as a graphical component in a graphical user interface (“GUI”), as shown in FIG. 5C.

Referring now to FIG. 5C, an example GUI of a seller's smart offer analytics interface 500 is shown. The seller's smart offer analytics interface 500 may include multiple regions to display and illustrate to the seller various information and data. Additionally, the seller's smart offer analytics interface 500 may include multiple selectable components to interact with the seller's smart offer analytics interface 500. The seller's smart offer analytics interface 500 may include a smart offer analytics zone 504, selectable components 510, 512, offer price versus point value graph 530, and offer price versus down payment graph 540.

Smart offer analytics zone 504 may display all offers with associated offer details 506 (e.g., offered price, point value, percent down payment, days to close on escrow, contingency on home sale, and contingency days, etc.). In other embodiments, smart offer analytics zone 504 may display a subset of all offers (e.g., the top five most competitive offers with respect to a seller-defined criteria). Smart offer analytics zone 504 may also include selectable components 508 through which the seller may select a single or multiple offers. Upon selecting the offers, the smart negotiation system may present the seller with various options. These options may include accepting the offer, rejecting the offer, counteroffering the offer, messaging the buyer, viewing additional information, requesting financial verification, etc. Likewise, the seller may filter and sort the list of offers according to any criteria, including offered price, point value, percent down payment, days to close on escrow, contingency on home sale, and contingency days, etc. In some embodiments, the seller may only select one offer using selectable components 508, the seller may then select selectable component 510 to indicate that the selected offer is accepted. In some embodiments, the seller's dashboard may include a selectable component 512 by which the seller may select to reconsider the offers and make a manual decision within 24 hours.

Upon receiving an offer, the smart negotiation system generates a point value associated with the offer. The point value may be displayed in comparison to various offer inputs, such as the net offer price and the percent down payment. As illustrated in offer price versus point value graph 530, the net offer indicator 536 is displayed proximate the point value indicator 538. With this paradigm, the seller may efficiently view offers in the context of competitiveness, not merely the offer price. With the multi-faceted characteristic of offers to purchase property, many inputs affect the competitiveness of an offer. For example, in net offer price v. point value graph 530, the Lopez offer has a net offer indicator 536 to represent Lopez's offer of $1,120,000, higher than all other offers. However, Lopez's point value is lower than all other offers due to the low percent down offered. This low percent down affects the likelihood of the sale going through and is thus reflected in a lower point value indicator 538. It should be noted, any term of the offer may affect the point value.

Offer price v. down payment graph 540 is an example graphical interface to display the down payment indicator 546 in relation to the point value indicator 548 of the offer. As described above, by displaying the point value indicator visually in relation to a term of the offer (e.g., the percent down), the seller is empowered to consider competitiveness of each offer in real time without the need to search through tables of values, which can be time consuming and prone to error. In some embodiments, the graphs 530, 540 include interactive and selectable components. For example, a seller may select an indicator 536, 538, 546, 548 to display additional terms or information relating to the offer. Additional terms or information may include the offered price, the points value, the percent down, the days to close on escrow, the contingency on the sale of a home, the days of the contingency, biographical information, financial information, a buyer's highest point value within the buyer's affordability threshold, etc. The seller may use this additional information to inform the seller on what counteroffers to make to a buyer.

In another embodiments, the seller or buyer may grant access to their information and respective dashboards to an agent. The seller or buyer may choose to grant access to specific information (e.g., offers and terms of the offers) but not grant access to other information (e.g., sensitive personal information).

In some embodiments, when a seller's agent mode is enabled for a seller, the seller's agent is allowed control of the dashboard functions and actions. In such embodiments, the seller may still receive real-time notifications and alerts of offers received. In some embodiments, the seller is required to have an agent, but may not be required to offer full control of the seller's dashboard to the seller's agent. If the seller's agent mode is disabled, the seller remains in control of the dashboard functions and actions. In such embodiments the seller's agent may still receive real-time notifications and alerts.

In some embodiments, when a buyer's agent mode is turned on for the buyer, the buyer's agent is allowed control of the dashboard functions and actions. In such embodiments, the buyer may still receive real-time notifications and alerts (e.g., when a higher offer is received, the buyer's offer is accepted/rejected, etc.). When the buyer's agent mode is turned off for the buyer, the buyer remains in control of the dashboard functions and actions. In such embodiments, the buyer's agent may still receive real-time notifications and alerts.

Referring back to FIG. 2, the point value may be displayed to the seller on the seller's device next to the offer inputs of the buyer's offer. This allows the seller to review the individual inputs of the offer (e.g., percent down, net offer price, etc.) within the context of how competitive the offer is (e.g., the point value). Selling a property such as house is often the largest transaction that a person will make in their life. As such, sellers of properties (such as a house) often wish to be involved in the negotiation and transaction process. This is often not the case when an agent is involved in the process. When an agent is involved, offers are filtered through the agent and the seller has no way of knowing what kind of offers are being presented. By utilizing method 200, a seller of a property receives a notification of each offer made and can then instantly determine its overall competitiveness with respect to all other offer beyond merely comparing the net offer price. Additionally, in some embodiments, the smart negotiation system may present the seller with the point value of offers for comparable properties (e.g., properties with characteristics that are similar to the property for sale). In this way, the seller is notified if a property is receiving less competitive offers than comparable properties. This may lead the seller to update the seller's listing to attract higher offers. Alternatively, if the seller is notified of an outlier offer that is more competitive than offers for comparable properties, the seller may choose to quickly accept the higher-than-normal offer. In some implementations, a user device must be registered with the smart negotiation system or the VMS application on the user device to view generated point values or comparable property data.

Likewise, the point value generated in method 200 may be presented to the buyer in substantially the same manner as to the seller. In some embodiments, the smart negotiation system may display or otherwise transmit for display on the buyer's device the generated offer point value. The buyer may use the point value for different purposes than the seller. For example, the buyer may use the generated point value to determine their own competitiveness within a pool of offers. In some embodiments, the buyer may submit a proposed updated offer to the smart negotiation system to generate a point value for the proposed updated offer. This allows the buyer to check multiple permutations of the offer by changing various inputs to find that most competitive offer within a buyer's affordability threshold (as described herein) without officially sending the offer to the seller.

At step 208, the smart negotiation system receives at least one updated offer associated with the at least one offer to purchase the property. In some embodiments, the smart negotiation system is configured to receive the updated offer to purchase the property in substantially the same way as in step 202. In some embodiments, the buyer may submit a proposed updated offer to view the change to the point value without submitting an official offer. In this embodiment, the proposed offer is not transmitted to the seller and the seller is not notified of the proposed offer. In other embodiments, the seller may submit proposed inputs for a proposed offer to test the effects of various offer inputs. In doing so, a seller may competitively make counter offers to buyers.

At step 210, the smart negotiation system applies the model (e.g., the AI model) to an updated plurality of offer inputs and output an updated point value. In some embodiments, the smart negotiation system executes the AI model comparison system in substantially the same manner as previously disclosed herein.

At step 212, the smart negotiation system presents for display an updated graphical user interface having an updated interactive graphical component to include a first revised polygon representing the updated point value in a position of the second polygon representing the point value for the at least one updated offer. In some embodiments, the smart negotiation system displays or otherwise transmits for display the updated offer price and updated point value on a device in substantially the same manner as previously disclosed herein.

In some embodiments, upon the seller completing the sale proposal and the listing being submitted for sale, the smart negotiation system may present for display to a seller a seller's dashboard 570 as illustrated in FIG. 5B. Seller's dashboard 570 may display various data and information to a seller regarding received offers and the terms of the listing. For example, seller's dashboard 570 may include buyers' offers 572, smart offer analytics 574, offer management 576, and agent mode toggle 578. Buyers' offers 572 may include a list of all offers received and sorted by any seller-defined (or seller's agent-defined criteria). For example, the offers may be sorted by point value, date of receipt, down payment, closing date, etc.

Smart offer analytics 574 may display various graphs comparing the offer terms to an associated point value (as show in in greater detail in FIG. 5C). The smart offer analytics 574 may be associated with a selectable component with which the seller may navigate to the user interface of FIG. 5C. The offer management 576 allows the seller to view the offer submission deadline (by either date or countdown), extend the deadline for submissions (in some embodiments, this feature may only be available within twenty-four hours of the deadline), edit the reserve price through interacting with a user input component of the interface, send a notification to all buyers to submit a highest and best offer, and increase the minimum offer increase threshold.

The agent mode toggle 578 functions much like the agent mode toggle of the buyer's dashboard. The seller may enable the agent mode upon selecting the agent mode toggle 578. In agent mode, the agent has full control over the seller's dashboard 570 and the seller will receive real-time notifications and alerts of events during the transaction. The seller may toggle on and off the agent mode at any time. When toggled on, the seller's agent may access the seller's dashboard 570 from the seller's agent device.

In some embodiments, the polygons described herein in FIG. 2 may be represented by bars on a bar graph. The bars may extend vertically from a horizontal axis, horizontally from a vertical axis, or otherwise extending in a three-dimensional environment. The bars and graph may be modified based on the seller's preferences (e.g., changing color, scaling, sizing, axis range, etc.). In other embodiments, the polygons may be superimposed on a single polygon. For example, a single bar may display the information relating to both the net offer price of an offer and the down payment of the offer. By way of an example, a single vertically extending polygon may be bisected by horizontal line to indicate the net offer price and the down payment on the same bar. In this manner, the information generated by the smart negotiation system is further consolidated, particularly important today when electronic devices are growing ever smaller. In similar manners, the bars of the bar graph (or representations on any kind of graph) may be modified to communicate more or less data.

In displaying the analyzed and generated information in this manner, a technical problem is solved. In today's traditional methods and systems, offers are not displayed with relevant and efficient comparative data in the same location as where the seller negotiates the transaction. By positioning the point value in proximity of the offer details (as described herein), the seller overcomes traditional frictions in the negotiation process of being required to navigate between various applications and interfaces when comparing offers.

As used herein (above and below), the term “polygon” should not be construed in any manner as limiting the present disclosure to a single embodiment. In other embodiments, the disclosed polygon may take the form of any one-, two-, or three-dimensional shape or representation. The polygon disclosed (i.e., any representation of the values discussed) may be of any color, shape, size, or variation. While certain embodiments disclosed present a visual representation, it should be understood that the polygon may be represented both tactilely and aurally as well. Any polygon disclosed herein may be interactive (regardless of the variation or form taken) and may be selectively interactive to execute one or more computer logic scripts. Likewise, the disclosed polygons may be adaptable and update in real time in response to various user inputs, interactions, or commands. Likewise, the disclosed polygons may be adaptable and update in real time in response to various informational changes (whether user initiated or otherwise).

While different in substance, the embodiments and variations of the polygons of FIG. 3 may be described and varied in substantially the same manner as the polygons of FIG. 2 disclosed herein.

Referring now to FIG. 3, a flowchart for a method 300 of applying an AI model to a plurality of inputs to determine a singular point value for an offer to purchase a property is shown, according to an embodiment. The virtual marketspace system 100 of FIG. 1A can be configured to perform method 300. Furthermore, any computing device described herein can be configured to perform method 300. In some embodiments, method 300 is performed locally on the buyer device 102 of FIG. 1A, seller device 104, or seller device 104 of FIG. 1A, or the smart negotiation system 106 of FIG. 1A.

In broad overview of method 300, at step 302, one or more processing circuits receive at least one offer to sell a property. At step 304, one or more processing circuits apply a model (e.g., an AI model) configured to value the property and generate an affordability threshold by inputting a plurality of property inputs and a plurality of pricing inputs and outputting a suggested comparable value of the property, a lower comparable suggested value of the property, an upper comparable suggested value of the property, and the affordability threshold. At step 306, one or more processing circuits present for display in a first region of a graphical user interface, an interactive graphical component representing the at least one offer to sell the property, wherein the interactive graphical component includes, for the property a first polygon extending from an axis to represent an asking price of the property, a second polygon extending from the axis to represent the comparable suggested value of the property, a third polygon extending from the axis to represent the lower comparable suggested value of the property, a fourth polygon extending from the axis to represent the upper comparable suggested value of the property, and a first affordability threshold marker to represent the affordability threshold. At step 308, one or more processing circuits receive at least one offer to purchase the property. At step 310, one or more processing circuits apply the model to the plurality of property inputs, the plurality of pricing inputs, and a plurality of offer inputs and outputting an updated affordability threshold. At step 312, one or more processing circuits present for display a fifth polygon extending from the axis to represent the at least one offer to purchase the property and a second affordability threshold marker in a position of the first affordability threshold marker to represent the updated affordability threshold. While an example method is shown in FIG. 3, it should be understood that additional, fewer, or different options may be performed in the method in view of particular circumstances. For example, in some embodiments, some or all of the operations of method 300 are performed by one or more processors executing on one or more computing devices, systems, or servers. In some embodiments, the steps of method 300 may be reordered or repeated. Combinations and variations of the operations and methods described herein are also included within the scope of the present disclosure (e.g., the incorporation of one or more steps of method 200 of FIG. 2).

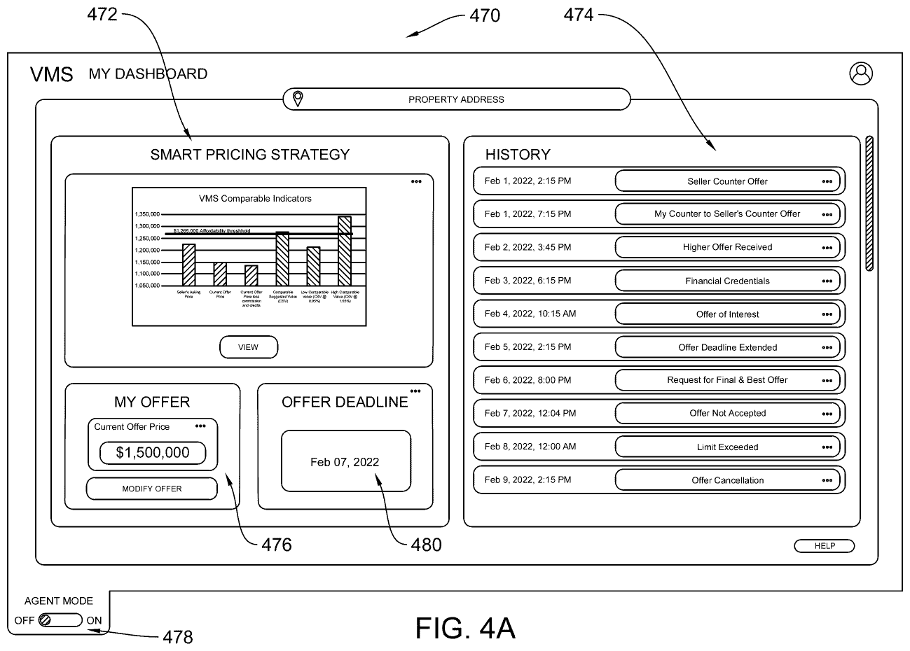

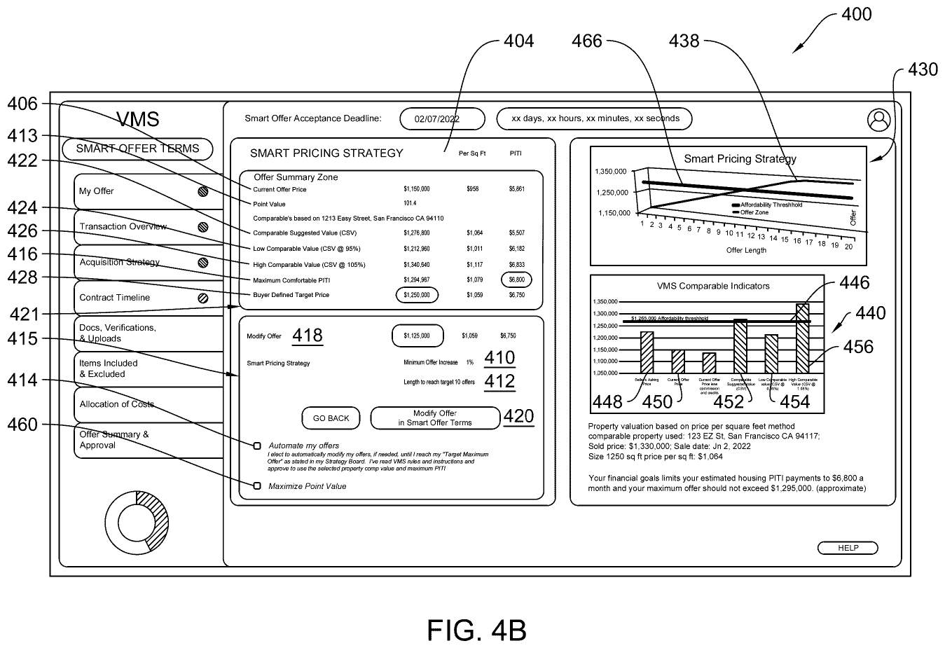

In general, method 300 depicts a method of analyzing a property for sale and a buyer's pricing inputs, using an AI model to generate comparable property values and an affordability threshold for the buyer. The comparable property values and affordability threshold are presented to the user on a device for the user (e.g., buyer or seller) to view. By viewing the comparable property data with the affordability threshold, a buyer is instantly able to determine whether or not a property is within the buyer's affordable range to purchase. This decision/determination is made instantaneous through the use of unique graphical depictions of the comparable property prices and the affordability range (as shown in FIG. 4A and FIG. 4B).

Referring now to FIG. 4A, an example GUI of a buyer's dashboard 470 is shown. The buyer's dashboard 470 is presented to, and accessible by, the buyer once the buyer has made an offer that was accepted by the offer verification system 139 of FIG. 1A. The buyer's dashboard 470 may include multiple regions to display and illustrate to the buyer various data and information. According to one embodiment, the buyer's dashboard 470 may include a smart pricing strategy graph 472, an event history 474, a current offer indication 476, an agent mode toggle 478, and an offer deadline indication 480. The buyer may also be able to modify the buyer's offer from the buyer's dashboard by selecting a selectable component.

The buyer's dashboard 470 may be displayed on the buyer device 102 of FIG. 1A to communicate to the buyer information relating to the buyer's pending offer. Smart pricing strategy graph 472 may display in a bar graph the seller's asking price, the current offer price, the offer price less commission and credits, a comparable suggested value, a lower comparable suggested value, and a higher comparable suggested value. Additionally, the smart pricing strategy graph 472 may display the buyer's affordability threshold as determined by the pricing system 134 of the smart negotiation system 106 of FIG. 1A.

The buyer's dashboard 470 may also display the buyer's current offer price at the current offer indication 476, the offer deadline at the offer deadline indication 480, and a chronology of events associated with the buyer's offer in the event history 474. In some embodiments, the buyer may toggle on the agent mode toggle 478 to enable an agent mode. When enabled, the agent mode allows an agent to have control over the functions of the buyer's dashboard 470. In such an embodiment, the buyer may still receive real-time notifications and alerts. As with the seller's agent mode toggle option, the buyer may enable and disable the agent mode toggle at any time.

Referring now to FIG. 4B, an example GUI of a buyer's smart pricing strategy interface 400 is shown. The buyer's smart pricing strategy interface 400 is available to the buyer prior to submission of the buyer's offer to assist in selecting a competitive offer relative to the real value of the property being sold. The buyer's smart pricing strategy interface 400 is available to the buyer after submission of the offer if the buyer would like to make modifications to the buyer's offer. The buyer's smart pricing strategy interface 400 may include multiple regions to display and illustrate to the buyer various forms of information and data. Additionally, the buyer's smart pricing strategy interface 400 may include multiple regions for the buyer to input data, both financial and personal. The buyer's smart pricing strategy interface 400 may include various regions such as an offer summary region 404, an offer input region 415, a comparable property value region 421, a smart pricing strategy graph 430, and a VMS comparable indicator graph 440. In some embodiments the various regions included in buyer's smart pricing strategy interface 400 are interactive. For example, the buyer may interact with the various regions of buyer's smart pricing strategy interface 400 through the use of an input device such as an alphanumeric keyboard, mouse, a microphone, etc.

The terms selectable and activatable are used interchangeably herein. Selectable or activatable icons presented as part of example GUIs may cause a signal to be generated upon selection or activation. The signal may be transmitted to a system, device, or application to indicate to the device, system, or application which icon has been selected, and the device, system, or application may respond accordingly.

The offer summary zone 404 may include various data. Such data may include a current offer price 406, a minimum offer increase 410, a length to reach target 412, and a point value 413. Additionally, the offer summary zone 404 may include selectable component 414, which upon receiving an interaction from the buyer automatically increases the offer price when a higher offer is received by the seller. In some embodiments, the automatic increases to the offer price will not exceed a buyer defined target price 428 which the buyer may set through inputs to the smart negotiation system through the user device. In some embodiments, the user uses a VMS application interface on the buyer's device to input the buyer defined target price 428 and all other buyer input information. The buyer's smart pricing strategy interface 400 may also be presented on the user device through the VMS application interface. Additionally, the automatic offer increase will automatically increase to outbid another offeror by increasing by a minimum offer increase 410 as defined by the seller through the seller's VMS application interface. In some embodiments, buyer's smart pricing strategy interface 400 displays the amount of offer increases available (by increasing by the minimum offer increase 410) until the buyer defined target price 428 amount is reached. The offer summary zone 404 may also display data to the buyer with respect to the price per square foot and estimated monthly payment for the current offer price and target maximum offer. In some embodiments, the point value 413 of the buyer's offer is shown in the offer summary zone when the buyer has submitted an offer to the seller or is making proposed offers. In some embodiments the buyer may interact with the offer summary zone 404 by selecting the current offer price 406, the buyer defined target price 428, the minimum offer increase 410, the length to reach target 412, and the point value 413. Upon receiving an indication of a selection of at least one of the current offer price 406, the buyer defined target price 428, the minimum offer increase 410, the length to reach target 412, and the point value 413, the smart negotiation system may present for display on the buyer's device an input component in which the user may modify the selection (e.g., the current offer price 406, the buyer defined target price 428, etc.). Upon submitting the modification, the smart negotiation system may display once again buyer's smart pricing strategy interface 400, now updated with the modified input.

Smart pricing strategy interface 400 may also include a maximum comfortable monthly payment 416 (e.g., the sum of principal, interest, taxes, and insurance). According to an embodiment, the maximum comfortable monthly payment 416 may be associated with a selectable component by which the buyer may modify the maximum comfortable monthly payment 416. Upon modifying the maximum comfortable monthly payment 416, the buyer's smart pricing strategy interface 400 updates to reflect the modification.

Likewise, the smart pricing strategy interface 400 may include an additional selectable component 420 with which to modify the current offer price 406. In both instances, according to some embodiments, the buyer may select the selectable component to modify the respective amount. Upon the buyer submitting the modification, a buyer's Smart Offer Terms update automatically in real time to reflect the modifications. The buyer's Smart Offer Terms are stored in a database of user-selected offer terms as submitted by the user through the smart pricing strategy interface 400. The terms may be used by the smart negotiation system 106 of FIG. 1A to create a contract from the terms if the seller accepts the buyer's offer. This process may use AI and machine learning to generate the contract based on the collected information of the buyer's offer and the seller's listing.

In other embodiments, the buyer's Smart Offer Terms includes additional informational inputs for the buyer to include various other data to increase the efficiency of the smart negotiation system AI model. For example, the buyer may input into the buyer's Smart Offer Terms the buyer's banking information, loan preapproval information, debts, additional sources of income, bank statements, retirement goals, liabilities, previous transactions, biographical information, etc. The AI model of the smart negotiation system generating the buyer's Smart Offer Terms then uses the various data as inputted by the buyer, as well as relevant data collected from the comparable housing database and financing database, to generate an affordability threshold marker 466, an offer zone 438, a comparable suggested value 422, a low comparable suggested value 424, and a high comparable suggested value 426. The smart negotiation system then, through the AI model pricing system (as shown in FIG. 1A), displays these generated values (the affordability threshold 466, the offer zone 438, etc.) in various interactive graphical interfaces to efficiently communicate the generated values to the buyer. The smart pricing strategy graph 430 and the VMS comparable indicator graph 440 are two embodiments depicting example interactive graphical interfaces. For example, in the smart pricing strategy graph 430, the affordability threshold 466 is depicted as a line on a graph, overlaying the offer zone 438, the offer zone representing the range from low comparable suggested value 424 to the high comparable suggested value 426. VMS comparable indicator graph 440 also displays the AI generated information in a communicably efficient manner. By overlaying the affordability threshold 446 over the seller's asking price indicator 448, the current offer price indicator 450, the comparable suggested value indicator 452, the low comparable suggested value indicator 454, and the high comparable suggested value 456, a buyer may immediately determine where the buyer's affordability range falls within a range of suggested values for the property. This improves upon the traditional method of viewing such data in a table in which a buyer would have to sort and scan through to make a determination. In today's transactional markets, sales happen at increasingly fast paces through the use of instant communication. As such, increases in speed and efficiency in generating, viewing, and comparing information (such as illustrated in the smart pricing strategy graph 430 and the VMS comparable indicator graph 440) is becoming increasingly necessary.

In some embodiments, the VMS comparable indicator graph 440 is interactive. Unlike traditional bar graphs, the VMS comparable indicator graph 440 may have selectable components associated with the indicators 448, 450, 452, 454, 456, 446. For example, a user may select (through clicking, dragging, etc.) the affordability threshold indicator 446 and drag it up or down on the graph. Upon doing so, the pricing system of the smart negotiation system updates in real time various buyer inputs to result in the modified affordability threshold marker. For example, upon raising the affordability threshold marker, the AI model may adjust the maximum comfortable monthly payment 416. In some embodiments, the user may select certain criteria to remain static during the updating process. For example, the user may select the maximum comfortable monthly payment 416 to remain static. In such an embodiment, other offer inputs may be modified by the AI model, such as percent down, loan interest rate, target maximum offer, etc. This interactivity empowers a buyer to view what changes need to be made to the buyer's offer to achieve a certain price.

In some embodiments, the buyer may be able to modify the current offer price indicator 450 to modify the current offer. The user may select and drag the current offer price indicator 450 to either raise or lower the offer on the VMS comparable indicator graph 440. As described above, various offer inputs may be adjusted by the smart negotiation system to reflect the updated offer while maintain the buyer's financial goals as inputted into the smart negotiation system. Likewise, the AI model may update the point value 413 associated with the affordability threshold and display the updated point value upon the user selecting the new affordability threshold or upon the user updating the offer terms. In some embodiments, the buyer dashboard may display the point values of other offers received by the seller, so as to assist the buyer in adjusting the terms of the buyer's offer to achieve the highest point value (e.g., the most competitive offer). It should be noted that the point value is a result of all the inputs of the offer, and not just the net offer price. Thus, a buyer need not raise the net offer price to achieve a higher point value, and thus offer the most competitive offer. In some embodiments, a notification may be displayed upon the smart negotiation system receiving an indication that the user is attempting to adjust the current offer price indicator higher than the affordability threshold 446. In such an example, the notification may alert the buyer that the buyer is attempting to offer a price higher than the generated affordability threshold. This notification may also be sent to parties other than the buyer (e.g., a spouse, a parent, a financial institution, etc.). The AI model may account for an offer above the buyer's affordability threshold by reducing the point value to communicate to the seller that the offer is less competitive. Likewise, a notification may be sent to the seller in real time to notify the seller that the offer is beyond the buyer's generated affordability range once the buyer confirms and submits the offer. In some embodiments, the smart negotiation system will not allow a user to make an offer above the affordability threshold.

In some embodiments, the smart pricing strategy interface 400 may display a selectable component 460. Upon the user selecting selectable component 460, the AI model of the smart negotiation system iteratively calculates offers of different terms to generate an offer with terms that result in the maximum point value within the buyer's affordability threshold and with respect to a seller's chosen preferences. This allows a buyer to maximize their competitiveness of the buyer's offer. In some embodiments, the buyer may grant access to a seller to view the buyer's maximum point value through the seller's dashboard.

Upon selecting an offer amount with offer terms, the user may continue through additional dashboards and graphical user interfaces to further provide additional terms of the offer, verify and upload documents, review the offer, and submit the offer to the seller.

According to an exemplary embodiment, when the buyer submits an offer through the buyer's smart pricing strategy interface 400, the offer is sent to the offer verification system 139 of FIG. 1A for offer verification before being transmitted to the seller to review. The offer verification system 139 may receive various data from buyer device 102 and the financing database 140 of FIG. 1A to be used in executing an offer verification test. The offer verification is a three-step process (e.g., Test A, Test B, and Test C), according to some embodiments. In order for the offer to be verified, the offer must pass all three steps of the verification process.

Test A checks whether the offer package is complete. For an offer package to be complete it must include a signed offer with all relevant terms (e.g., price, date, buyer, down payment, etc.), proof of the buyer's qualifications, and all property disclosures acknowledged and signed. If an offer is missing any of these documents, it will be sent back to the buyer for completion.

Test B checks whether the offer price is reasonable. The seller has expectations of a reasonable offer as suggested by the sale price of comparable sales in a current comparable marketplace analysis. As such, the seller may not entertain low ball offers. If the buyer attempts to make an offer that is too low, the offer will be sent to the buyer for reconsideration or withdrawal. In some embodiments, the seller's reserve price is used to determine a minimum offer threshold that will be used in determining if an offer is reasonable.

Test C check whether the buyer is qualified to close the transaction. The buyer's financial credentials, as evidenced by an uploaded proof of funds and direct lender's pre-approval letter, have to be provided to complete the transaction. If the system detects insufficient funds or an incorrect pre-approval loan amount, the offer will be sent back to buyer for correction. Alternatively, the buyer may be prompted to upload additional supporting documents.

The offer verification system 139 may employ AI or machine learning to perform the various verification processes and tests. This may include analyzing documents, checking signatures, comparing the offer price to comparable suggested values, etc.

In some embodiments, the buyer's smart pricing strategy interface 400 includes a disclaimer.

Referring back to FIG. 3 in more detail, at step 302, the smart negotiation system receives at least one offer to sell a property. The property may be of any form, including, but not limited to real estate, intellectual, personal, etc. According to some embodiments, the smart negotiation system is an application stored and executed locally on a user device (e.g., a buyer's, seller's, or agent's device). Alternatively, the smart negotiation system may be stored and executed remote to the user device on a server, or an otherwise remote device configured to execute processing logic. A seller may interact with a user device (e.g., the seller's device) to input a plurality of offer inputs into the smart negotiation system through a variety of input devices including alphanumeric keyboard, a joystick, microphone, mouse, buttons, etc. These inputs may be inputted directly into the smart negotiation system or may be transmitted from a smart negotiation system application interface on the seller's device. An example of a seller's interface for submitting a listing is shown in FIG. 5A.

Referring now to FIG. 5A, a seller's market pricing strategy interface 550 is shown. The seller's market pricing strategy interface 550 may be used by the seller in determining a reasonable listing price for a property based on comparable property prices. The seller's market pricing strategy interface 550 may include various regions to display various data and information to the seller. For example, the seller's market pricing strategy interface 550 may include a comparable property zone 552, a comparable property information zone 554, a market pricing strategy zone 556, and a price placement in the market space graph 560. Comparable property zone 552 may include user input components associated with various property characteristics. For example, a seller may select a user input component to define the address of a comparable property. Comparable property information zone 554 may include various user input components with which the seller may interact to define the characteristics of the comparable property. For example, the seller may input the sold price, closing date, and square footage of the comparable property. The market comparison system 137 of FIG. 1A may then use the inputted data of the comparable property, the properties of the list property (e.g., square footage, address, zoning, etc.), and any other relevant data received from the comparable property database 138 to generate a comparable suggested value, a lower comparable suggested value, and a higher comparable suggested value. In some embodiments, the seller's market pricing strategy interface 550 may display the price per square foot and the estimated monthly payments for the various comparable suggested values generated. In some embodiments, the user inputs the list property's square footage in selectable component 558. After analyzing the generated suggested comparable values, the seller may input a listing asking price in a selectable component 562 (the amount the seller is asking for the property), a reserve price in a selectable component 564 (the minimum offer price the seller is willing to accept), and a minimum offer increase in the a selectable component 566 (the minimum offer increase that a subsequent offer must have from the previous offer). The price placement in the market space graph 560 may be a bar graph in some embodiments. The bars displayed in the graph may represent the listing asking price, the reserve price, the comparable suggested value, the low comparable suggested value, and the high comparable suggested value. In displaying this disparate information in this method, the smart negotiation system allows a seller to more efficiently digest separate and distinct information.

In some embodiments, the comparable property database of FIG. 1A stores (or otherwise may collect) information related to comparable properties to the property for sale. The market comparison system 137 of FIG. 1A may use this information in generating the comparable suggested value. Upon the user inputting a listing asking price in selectable component 562, the reserve price in selectable component 564, and the minimum offer increase in selectable component 566 the user may submit the listing by interacting with a selectable component. Upon receiving an indication of an interaction with a predefined selectable component (e.g., a button with the text, “SUBMIT SALE PROPOSAL”), the listing is posted for sale on the virtual marketspace.

Referring back to FIG. 3 in more detail, in step 304, the smart negotiation system applies a model (e.g., an AI model) configured to value the property and generate an affordability threshold by inputting a plurality of property inputs and a plurality of pricing inputs and outputting a suggested comparable value of the property, a lower comparable suggested value of the property, an upper comparable suggested value of the property, and the affordability threshold. The affordability threshold is a threshold up to which a buyer may offer to purchase the property for while staying within the buyer's financial goals and abilities. In some embodiments, the buyer inputs a plurality of pricing/financial goals or constraints into the smart negotiation system. This data may be stored in the smart negotiation system's memory or directly used in the AI model pricing system to determine an affordability threshold. The user may directly input the constraints and goals into the smart negotiation system, or alternatively, the AI model may pull data from institutions, organizations, profiles, databases, etc. that are associated or otherwise linked to the buyer. Pricing/financial goals, constraints, and information that the AI model may use include, but are not limited to, bank statements, net worth, credit score, savings, liquid assets, desired monthly payments, debts, pay history and future earnings, business interests, financial information for relatives (e.g., spouse, parents, children, grandparents), etc. Additionally, the buyer may input a target maximum offer price which the buyer is willing to pay. The AI model may also collect data of individuals of similar financial situations in order to assist in generating an affordability threshold based on a macroeconomic analysis. The AI model then uses the inputted and collected data to determine an affordability threshold of the buyer.

As described herein, the AI model may use machine learning protocols to improve the accuracy of point values over time (e.g., learn a user's preferences when selecting offers and updating the algorithm or model to reflect those preferences).

At step 306, the smart negotiation system presents for display in a first region of a graphical user interface, an interactive graphical component representing the at least one offer to sell the property, wherein the interactive graphical component includes, for the property a first polygon extending from an axis to represent an asking price of the property, a second polygon extending from the axis to represent the comparable suggested value of the property, a third polygon extending from the axis to represent the lower comparable suggested value of the property, a fourth polygon extending from the axis to represent the upper comparable suggested value of the property, and a first affordability threshold marker to represent the affordability threshold. In some embodiments, the comparable suggested value is determined by the comparison system of the smart negotiation system. Data may be collected from the comparable property database to compare recent sales prices of properties with similar characteristics. Characteristics of the property may include square footage, number bedrooms, number of bathrooms, age of the property, amenities (e.g., granite counter tops, hardwood floors, high efficiency windows, etc.), a pool, neighborhood, recent updates, school district, exterior material, etc. The lower comparable suggested value may be a percentage of the comparable suggested value. For example, the lower comparable suggested value may be 95% of the comparable suggested value. The lower comparable suggested value may be based on a percentage of the comparable suggested value more or less than 95%, but not more than 100%. The higher comparable suggested value may be a percentage of the comparable suggested value. For example, the higher comparable suggested value may be 105% of the comparable suggested value. The higher comparable suggested value may be based on a percentage of the comparable suggested value more or less than 105%, but not less than 100%. The affordability threshold marker is a representation or indicator of the affordability threshold generated in step 304.

The comparable suggested values and the affordability threshold marker may be displayed on a visual graph on the user device to aid the buyer in determining an offer amount. The comparable suggested values and the affordability threshold marker may be displayed on the same visual graph for ease of comparison or may be displayed on separate visual graphs. In some embodiments, the comparable suggested values are displayed as polygons (e.g., bars) on a bar graph and the affordability threshold marker is a horizontal line intersecting the bars. In other embodiments, the affordability threshold marker is also a bar on the bar graph. Colors may be used to more distinctly differentiate the bars from each other. Additionally, the bars may be displayed with various patterns for further differentiation. The bars may extend vertically from a horizontal axis, horizontally from a vertical axis, or otherwise extending in a three-dimensional environment. The bars and graph may be modified based on the buyer's preferences (e.g., changing color, scaling, sizing, axis range, etc.). In other embodiments, the polygons may be superimposed on a single polygon. For example, a single bar may display the information of all comparable suggested values. By way of an example, a single vertically extending polygon may be bisected by multiple horizontal lines to indicate multiple price points associated with comparable suggested values. In this manner, the information generated by the smart negotiation system is further consolidated, particularly important today when electronic devices are growing ever smaller.

In displaying the analyzed and generated information in this manner, a technical problem is solved. In today's traditional methods and systems, an affordability threshold to a buyer often is not displayed in the same location as where the buyer must make an offer to purchase a property. By positioning the affordability threshold in proximity of the offer details, comparable suggested value, and the buyer's financial information, the buyer overcomes traditional frictions in the negotiation process of being required to navigate between various applications and interfaces when making a determination of offer details.

At step 308, the smart negotiation system receives at least one offer to purchase the property. The buyer may interact with the buyer device to select an offer amount in accordance with the affordability threshold and the comparable suggested values. In an embodiment, the buyer chooses an offer amount below the affordability threshold and within the lower comparable suggested value and the upper comparable suggested value.

Upon receiving the offer to purchase the property, at step 310, the smart negotiation system then applies the model to the plurality of property inputs, the plurality of pricing inputs, and a plurality of offer inputs and outputting an updated affordability threshold. In the event that the buyer altered or otherwise modified the offer or financial information, the model may update the affordability threshold. Likewise, changes in certain financial circumstances beyond the buyer's personal finances may warrant an update in the affordability threshold. For example, changing interest rates of a large transaction may affect the buyer's affordability threshold. Alternatively, changes in the property market may alter the comparable suggested values.

At step 312, the smart negotiation system presents for display a fifth polygon extending from the axis to represent the at least one offer to purchase the property and a second affordability threshold marker in a position of the first affordability threshold marker to represent the updated affordability threshold. In an embodiment, the offer price and the updated affordability threshold marker are displayed on the same graph as the originally displayed affordability threshold marker. In such an embodiment, the original affordability threshold marker is replaced by the updated affordability threshold marker.

As noted herein, while differing in substance, the polygons described in FIG. 3 may be described, modified, and varied in substantially the same manner as the polygons described in FIG. 2.

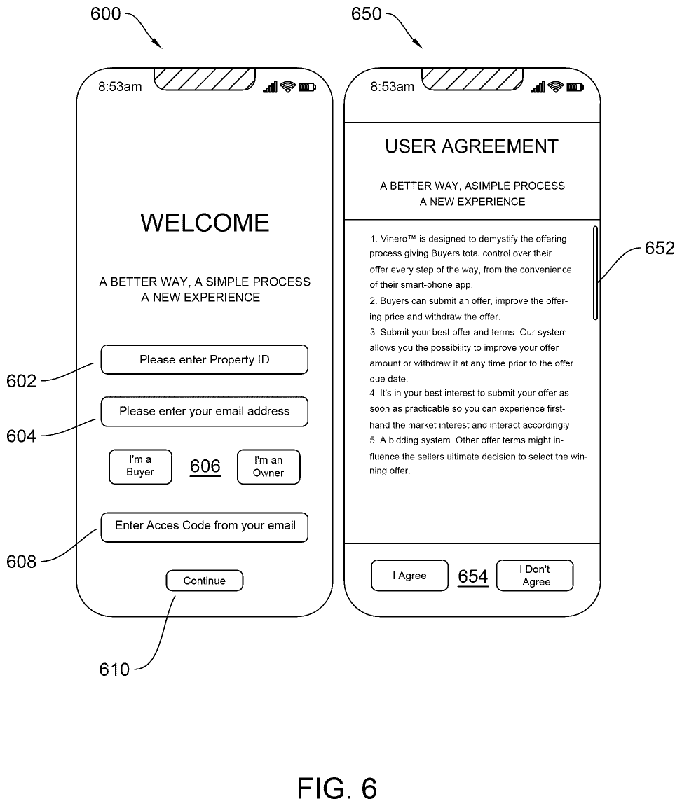

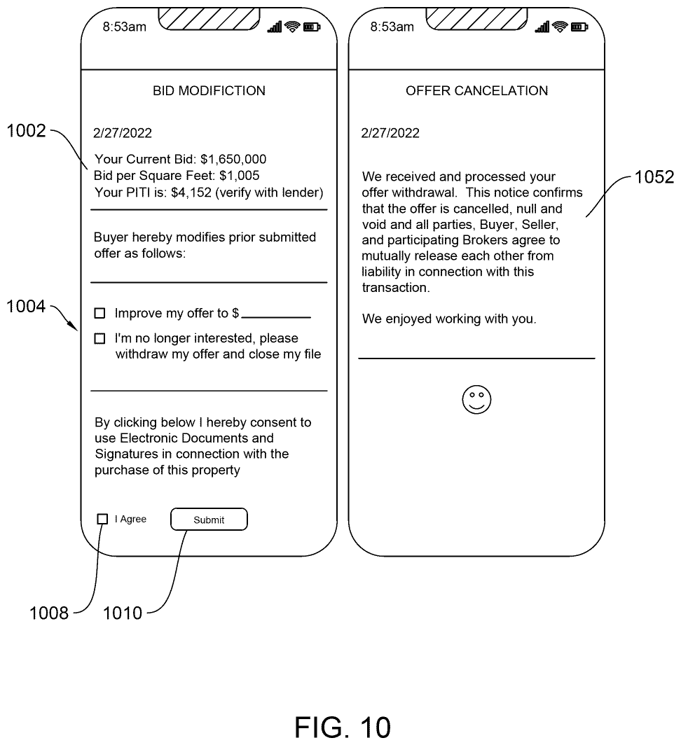

Referring now to FIGS. 6-14, example user interfaces of an interactive VMS are shown. In general, FIGS. 6-14 illustrate the smart negotiation system that can be rendered and executed (either remotely or locally) on both the buyer and seller device through the use of the VMS application interface. The VMS application interface may include a plurality of interfaces and objects with which the buyer/seller may interact and is used to execute the smart negotiation system.

As disclosed herein, the smart negotiation system and processing may be hosted remotely and accessed on the user's device through the use of the VMS application and associated interface or may be hosted and executed locally on the user device through the use of the VMS application.

In FIG. 6, various user interfaces 600, 650 are shown, according to an embodiment. User interface 600 is displayed on the user device (e.g., the buyer device or the seller device) upon accessing the smart negotiation system. Several selectable components 602, 604, 606, 608, 610 may be displayed on user interface 600. The user may interact (e.g., clicking on) with selectable component 602 to input a property to either offer for sale, make an offer to purchase, or otherwise view. The user may input the property information (e.g., geographical location, address, etc.) through text into selectable component 602, alternatively, the user may select a property from a drop-down menu. In other embodiments, upon selection of selectable component 602, the user device may launch a camera application with which the user may capture an image of a property. In some embodiments, the VMS application is configured to search a database of property photos with associated property information to match to the user's captured image in order to determine the property. Alternatively, the user may input a unique Property ID into selectable component 602. The Property ID may be uniquely provided to each property offered for sale on the smart negotiation system.

User interface 600 also may include selectable component 604, configured to receive, by the user, the user's email address. Again, the user may input the user's email address through text input, a dropdown menu, or the smart negotiation system may pull the user's email address from a known database storing the user's email address. Selectable component 606 prompts the user to indicate whether the user is a buyer or seller. The selection of selectable component 606 determines subsequent graphical user interfaces presented to the user. For example, upon selecting “I'm a Buyer” from selectable component 606, the smart negotiation system may present the buyer's dashboard and associated information on the buyer's device. Alternatively, upon selecting “I'm an Owner” from selectable component 606, the smart negotiation system may present the seller's dashboard and associated information on the seller's device. Upon receiving an indication of the user's email address, the smart negotiation system may transmit an authentication token to the user's email address with which the user may authenticate the user's email address. In some embodiments, the user may be required to input the authentication token (e.g., an access code) into selectable component 608. Upon inputting the required information in selectable components 602, 604, 606, 608 the user may select selectable component 610 to progress to a subsequent user interface 650.

User interface 650 displays a user agreement to which the user may agree or disagree with through selectable component 654. In some embodiments, the user agreement may span beyond the user's device's display. In such embodiments, a scroll bar 652 may be presented to the user. The user may select the scroll bar 652 to scroll up and down on the user agreement and any accompanying text. The user interface 650 may be configured to respond (by scrolling) upon a user selecting the scroll bar 652 and dragging up or down on the interactive display.

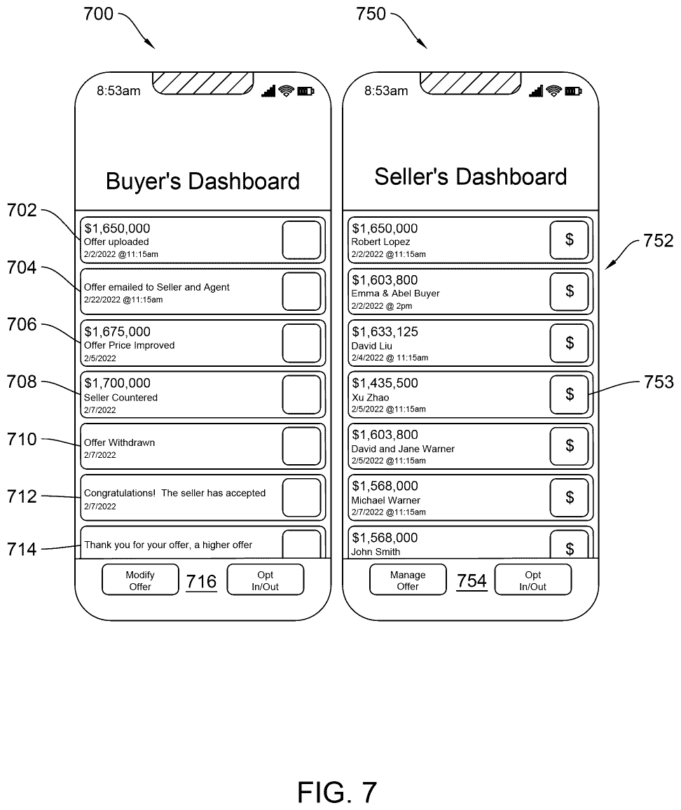

In FIG. 7, various user interfaces 700, 750 are shown, according to an embodiment. User interface 700 illustrates an example buyer's dashboard as may be displayed to the buyer using the smart negotiation system. In some embodiments, a timeline of actions 702, 704, 706, 708, 710, 712, 714 within the transaction process is shown on the user interface 700. For example, as depicted in user interface 700, a chronology of events is shown in which an offer was uploaded for $1,650,000 at action 702, the offer was emailed to the seller and agent at action 704, the buyer improved the offer to $1,675,000 at action 706, the seller counteroffered for $1,700,000 at action 708, the offer was withdrawn at action 710, etc. In some embodiments, the buyer may select the action 704 to open the email sent to the seller and agent. In some embodiments, the buyer may select any action 702, 704, 706, 708, 710, 712, 714 displayed on user interface 700 to display additional information or details associated with the action.

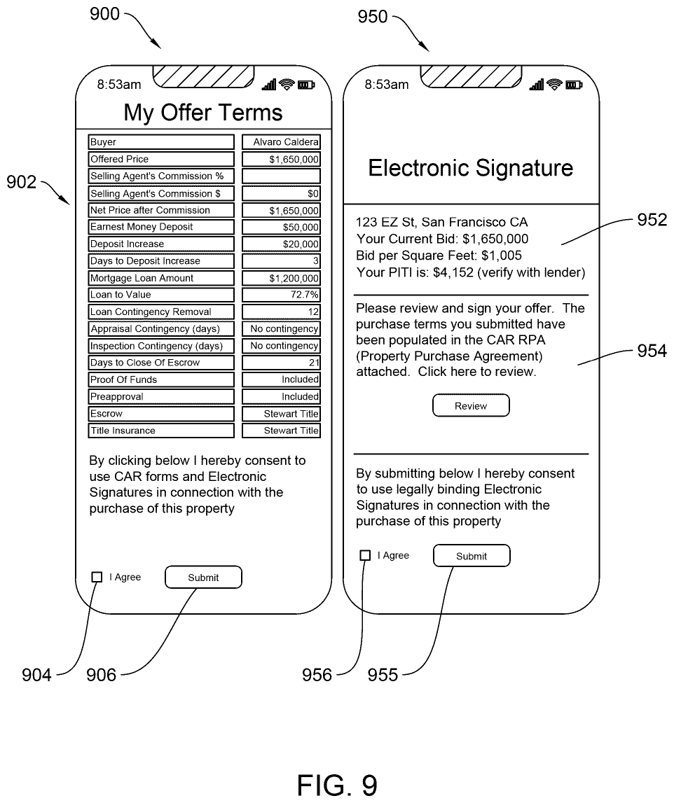

Selectable component 716 allows the buyer to modify the buyer's offer. Upon a user's selection of “Modify Offer” selectable component 716, the smart negotiation system may display user interface 900 of FIG. 9 to present the buyer with various selectable inputs to update/modify the buyer's offer. Selectable inputs 902 available to the user on user interface 900 of FIG. 9 include, but are not limited to, the buyer's name, offered price, selling agent's commission, net price after commission, earnest money deposit, deposit increase, days to deposit increase, mortgage loan amount, loan to value amount, loan contingency removal, appraisal contingency (in days), inspection contingency (in days), days to close of escrow, proof of funds, preapproval status, escrow information, and title insurance information. By selecting any of these inputs, the buyer may update the details of the buyer's offer either by supplying information (e.g., proof of funds), increasing the offer amount, changing a contingency status, etc. In some embodiments, the buyer may upload documents or photos to the smart negotiation system. User interface 900 may also include a selectable component 904 to indicate the buyer's agreement with an agreement policy and a selectable component 906 to submit the modified offer terms. Upon modifying the buyer's offer through user interface 900 and submitting the modified offer terms through selecting selectable component 906, the user may be presented with a signature page, such as illustrated by user interface 950 of FIG. 9. User interface 950 may include current bid information 952 (including property address/ID, current bid price, price per square foot, and estimated monthly payment), selectable component 954 through which the buyer may review and sign the updated offer upon selecting the selectable component 954, and a selectable component 956 to indicate the buyer's agreement with an agreement policy, and selectable component 958 through which the buyer may submit the updated offer upon selecting the selectable component 958. In some embodiments, the estimated monthly payment is based on an estimated cost of principal, interest, taxes, and insurance (“PITI”).

User interface 750 illustrates an example seller's dashboard as may be displayed to the seller using the smart negotiation system. In some embodiments, the seller is presented the seller's dashboard on the seller's device, by the smart negotiation system. The seller's dashboard may include a list of all pending offers 752 to purchase the seller's property. Each offer may include a buyer associated with the offer, a net offer price associated with the offer, and a date of receipt for the offer. In some embodiments, the point value as generated by the smart negotiation system may also be displayed with the offers. In yet other embodiments, additional offer details are presented on user interface 750. In some embodiments, a selectable component is displayed which allows the seller to sort and/or filter the multiple offers 752 according to a seller's filter criteria. For example, the seller may sort the offers from highest to lowest based on the point value. Alternatively, the seller may filter out any offers below a specified net offer price, as specified and inputted by the seller.

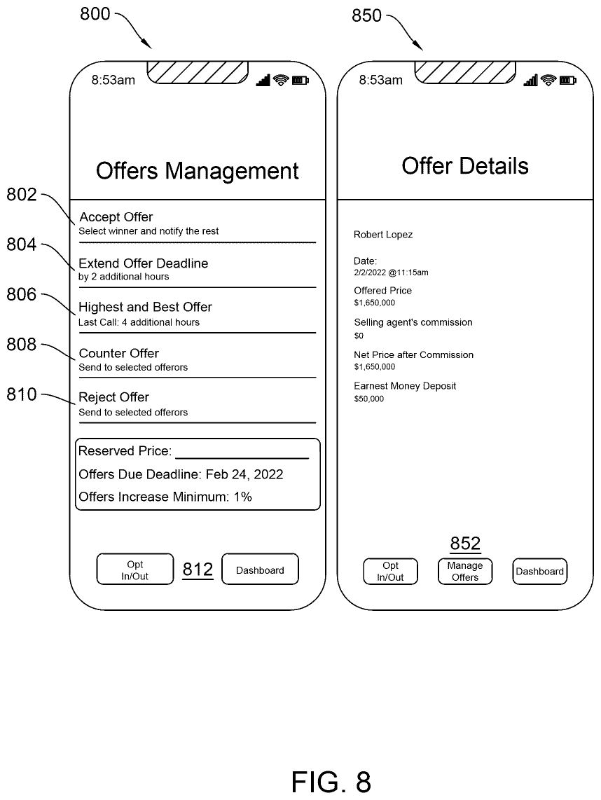

In other embodiments, the offers 752 may be, or have associated, selectable components (e.g., selectable component 753). In such embodiments, upon the seller selecting an offer, a profile is displayed on the user interface 850, as illustrated in FIG. 8. In some embodiments, the profile includes all of the details of the buyer's offer. In such embodiments, any hidden information on user interface 750 may be displayed so the seller may observe all relevant and available data associated with the offer. In some embodiments, not all information associated with the offer or buyer is displayed on user interface 750 or user interface 850.

Referring back to FIG. 7, user interface 750 also may include selectable component 754. The user may select “Manage Offer” at selectable component 754 to manage the various offers received by the seller. Managing offers may include many options. For example, the seller may accept an offer, counteroffer a buyer, view offer details with further filtering/sorting options, reject offers, etc. In some embodiments, upon selecting “Manage Offers,” the seller may be presented with the dashboard as illustrated in FIG. 5C. In other embodiments, the seller may be presented with user interface 800.

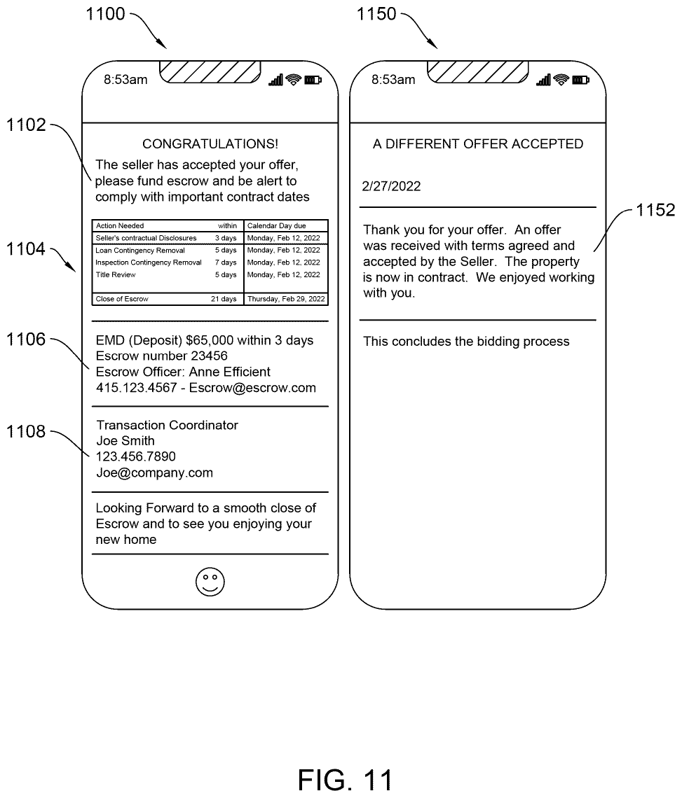

Referring to FIG. 8, various user interfaces are shown, according to an embodiment. User interface 800 illustrates a user interface including multiple selectable components 802, 804, 806, 808, 810 with which to manage the multiple offers received for the property for sale. The seller may select selectable component 802 to accept an offer and automatically generate a notification to the remaining buyers that another offer has been accepted, as shown in user interface 1150 of FIG. 11. User interface 1150 may include a notification message 1152 to notify the buyer that another buyer's offer was accepted. The smart negotiation system may also transmit the notification message 1152 to the buyer's agent. A notification may also be automatically sent to the buyer's device of the buyer whose offer was accepted by the seller, as illustrated in user interface 1100 of FIG. 11. The notification may be sent in real time and transmitted through the network as illustrated in FIG. 1A. User interface 1100 may include a notification message 1102 notifying the buyer that the seller has accepted the buyer's offer, subsequent steps table 1104 to notify the buyer of the next steps (e.g., seller's contractual disclosures, loan contingency removal, inspection contingency removal, title review, and close of escrow), escrow information 1106 to notify the buyer of requirements for an earnest money deposit and escrow information (escrow number, escrow officer, and contact information), and transaction information 1108 (e.g., transaction coordinator with associated contact information).

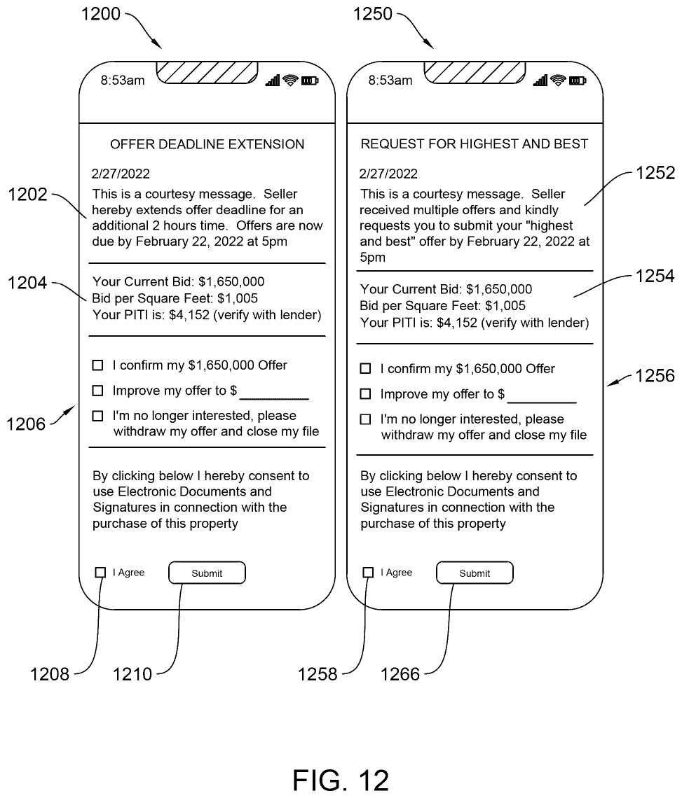

User interface 800 also may include a selectable component available within 12 hours of the offer deadline 804 to extend the offer deadline. In some embodiments, by selecting selectable component 804, the seller is presented with the option to extend the offer deadline by a selectable amount of time (e.g., hours, days, weeks, etc.). The seller may select an extension timeframe from a dropdown menu with preselected timeframes, input an extension timeframe through the use of an alphanumeric keyboard, or otherwise select an extension timeframe. By selecting to extend the offer deadline, the smart negotiation system may generate and transmit a notification automatically to all buyers with pending offers as shown in user interface 1200 of FIG. 12. User interface 1200 may also include a notification message 1202 to notify the buyer that the seller has extended the offer deadline, current bid information 1204, selectable component 1206 through which the buyer may confirm the current offer, improve the current offer, or withdraw the current offer. The user interface 1200 may also include selectable component 1208 to indicate the buyer's agreement with an agreement policy, and selectable component 1210 to submit the selection of selectable component 1206. In some embodiments, the buyer may not select the selectable component 1210 without previously selecting selectable components 1206, 1208. In some embodiments, the notification may include selectable components to update/modify the buyer's offer. The notification may be presented on the buyer's device, whether or not the VMS application is open and being executed.

User interface 800 may also include a selectable component 806 to request the highest and best offers from all buyers. By selecting to request the highest and best offers, the smart negotiation system may generate and transmit a notification to all buyers with pending offers to request a highest and best offer, as illustrated in user interface 1250 of FIG. 12. User interface 1250 may include a notification message 1252 to notify the buyer that the seller has requested the highest and best offer, current bid information 1254, a selectable component 1256 to respond to the request (e.g., confirm current offer, improve current offer, or withdraw current offer), a selectable component 1258 to indicate the buyer's agreement with an agreement policy, and a selectable component 1260 submit the selection of selectable component 1256. In some embodiments, the buyer may not select the selectable component 1260 without previously selecting selectable components 1256, 1258. The notification may include selectable components to update/modify the buyer's offer. The notification may be presented on the buyer's device, whether or not the VMS application is open and being executed.

User interface 800 may also include selectable component 808 to send a counteroffer to at least one buyer. In some embodiments, the seller may send a counteroffer to all buyers with pending offers. Upon selecting selectable component 808, the seller may be presented with selectable inputs to define a counteroffer for at least one buyer. Example inputs presented to the seller include a counteroffer price, required percent down amount, required days to close, request for more information, etc. Upon making a counteroffer through the presented inputs, a notification may be sent to the at least one buyer to notify the at least one buyer of the seller's counteroffer.

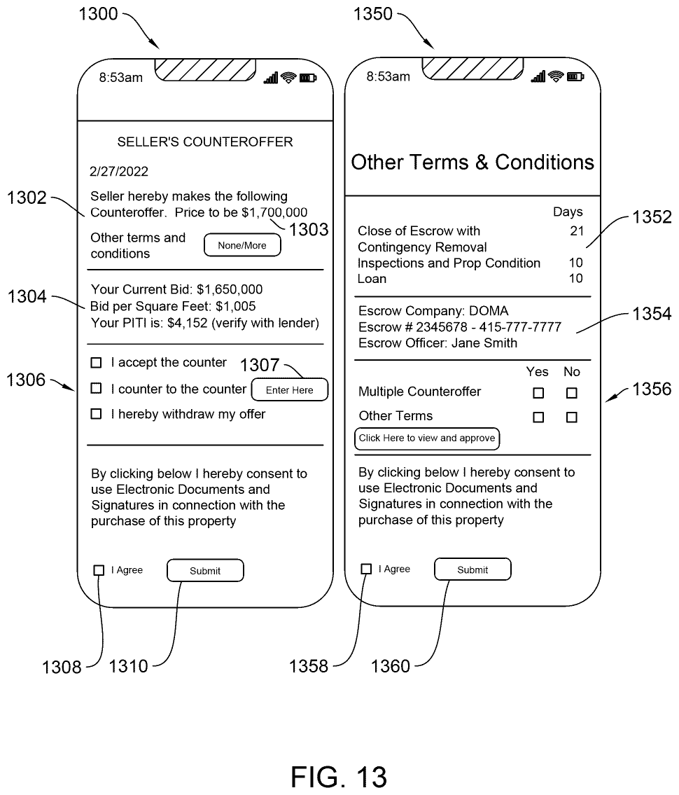

An example counteroffer notification is illustrated in user interface 1300 of FIG. 13. The notification may include a notification message 1302 notifying the buyer of the seller's counteroffer and the seller's counteroffer price 1303; other terms and conditions; current offer details 1304 (including the current offer price, price per square foot, and estimated monthly payment); selectable component 1306 to either accept the counteroffer, make a counteroffer, or withdraw the current offer; selectable components 1308 to indicate the buyer's agreement with an agreement policy; and selectable component 1310 to submit the selection for selectable component 1306. In some embodiments, the buyer may not select the selectable component 1310 without previously selecting selectable components 1306, 1308. Upon the buyer selecting to counter the seller's counteroffer with selectable component 1306, the buyer may enter or otherwise input a counteroffer amount at selectable component 1307.

User interface 800 may also include selectable component 810 to reject a current offer or offers. In some embodiments, a seller may decide to completely reject a buyer's offer. In such embodiments, the seller may select selectable component 810 to reject an offer and automatically notify the rejected buyer of the rejection.

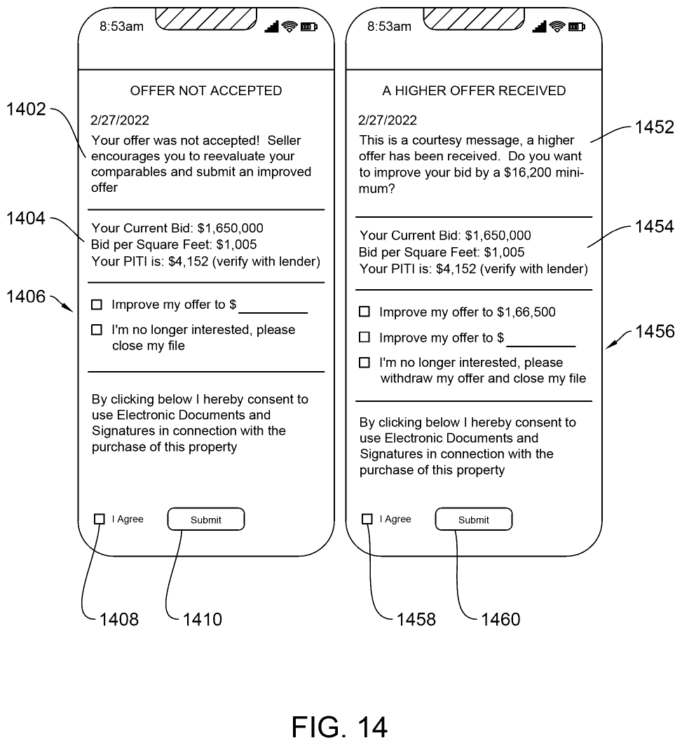

User interface 800 may also include selectable component 812 to display the seller's smart offer analytics interface 500 as depicted in FIG. 5 or in user interface 750 of FIG. 7. In some embodiments, the seller may choose a “reserve price.” The reserve price is a lowest minimum price at which the seller will be notified of an offer. For example, any offers less than the reserve price will not be presented to the seller, and the buyer will be notified and prompted to adjust the rejected offer. An example rejection notification is illustrated in user interface 1400 of FIG. 14. User interface 1400 may include a notification message 1402 that the buyer's offer was not accepted, current offer details 1404, selectable component 1406 to improve the current offer or withdraw the current offer, selectable component 1408 to indicate agreement with an agreement policy, and a selectable component 1410 to submit the selection for selectable component 1406. In some embodiments, the buyer may not select the selectable component 1410 without previously selecting selectable components 1406, 1408.

In some embodiments, the buyer may choose to modify the buyer's offer. In such embodiments, the buyer may use user interface 1000 to view the current bid information 1002, interact with selectable component 1004 to either modify the current offer or withdraw the current offer, select selectable component 1008 to indicate the buyer's agreement with an agreement policy, and submit the selection of selectable component 1004. In some embodiments, the buyer may not select the selectable component 1010 without previously selecting selectable components 1004, 1008. User interface 1050 depicts an example notification 1052 that the buyer may receive upon withdrawing the buyer's offer.

Referring to FIG. 13, user interface 1350 depicts other terms and conditions for a seller. In some embodiments the seller is presented with property sale details 1352 (e.g., days to close escrow, contingency removal, inspections and property disclosure deadlines, and loan deadlines). In some embodiments, the seller may also be presented with escrow data 1354 (e.g., the escrow company, the escrow officer, and the escrow contact information). Selectable component 1356 allows the seller to select whether to allow multiple counteroffers. Finally, user interface 1350 may include selectable component 1358 to indicate a seller's agreement with an agreement policy and selectable component 1360 through which a seller may submit the seller's additional terms and conditions as determined by the selection of selectable component 1356.

Upon the seller newly receiving an offer, a notification is automatically sent to all buyers with pending offers less than the newly received offer, such as illustrated in user interface 1450 of FIG. 14. User interface 1450 may include a notification message 1452 to notify the buyer that a higher offer was received by the seller, a current bid information 1454, a selectable component 1456 through which the buyer may respond to the notification (e.g., improve the current bid by the minimum increase amount, improve the current bid by a buyer-selected amount, or withdraw the current offer), a selectable component 1458 to indicate the buyer's agreement with an agreement policy, and selectable component 1560 to submit the selection of selectable component 1456. In some embodiments, the buyer may not select the selectable component 1460 without previously selecting selectable components 1456, 1458.

As used herein, the term “resource” refers to a physical or virtualized (for example, in cloud computing environments) computing resource needed to execute computer-based operations. Examples of computing resources include computing equipment or device (server, router, switch, etc.), storage, memory, executable (application, service, and the like), data file or data set (whether permanently stored or cached), and/or a combination thereof (for example, a set of computer-executable instructions stored in memory and executed by a processor, computer-readable media having data stored thereon, etc.).

The embodiments described herein have been described with reference to drawings. The drawings illustrate certain details of specific embodiments that provide the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuitry” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory).

Alternatively, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be provided as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud-based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud-based server). To that end, a “circuit” as described herein may include components that are distributed across one or more locations.

Example systems and devices in various embodiments might include a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general-purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick, or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the smart table system may be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes, and omissions may be made in the design, operating conditions, and arrangement of the embodiments without departing from the scope of the present disclosure as expressed in the appended claims.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be carried out in combination or in a single implementation. Conversely, various features that are described in the context of a single implementation can also be carried out in multiple implementations, separately, or in any suitable sub combination. Moreover, although features may be described above as acting in certain combinations and even initially claimed as such, one or more features from a claimed combination can, in some cases, be excised from the combination, and the claimed combination may be directed to a sub combination or variation of a sub combination. Additionally, features described with respect to particular headings may be utilized with respect to and/or in combination with illustrative implementations described under other headings; headings, where provided, are included solely for the purpose of readability, and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method of presenting for display a graphical user interface on a user device, the method comprising:
receiving, by a server, at least one offer to purchase a property;
applying, by the server, a model configured to value the at least one offer by inputting a plurality of offer inputs and outputting a point value based on the plurality of offer inputs;
presenting, by the server, for display in a region of the graphical user interface, an interactive graphical component representing the at least one offer to purchase the property, wherein the interactive graphical component includes, for the at least one offer, a first polygon extending from an axis to represent a net offer price and a second polygon extending from the axis to represent the point value; and
responsive to receiving, by the server, at least one updated offer associated with the at least one offer to purchase the property:
applying, by the server, the model to an updated plurality of offer inputs and outputting an updated point value; and
presenting, by the server, for display an updated graphical user interface having an updated interactive graphical component to include a first revised polygon representing the updated point value in a position of the second polygon representing the point value for the at least one updated offer.

2. The method of claim 1, further comprising:
presenting, by the server, for display in a second region of the graphical user interface, a second interactive graphical component representing the at least one offer to purchase the property,
wherein the second interactive graphical component includes an offeror associated with the at least one offer to purchase the property, and
wherein the second interactive graphical component displays the plurality of offer inputs associated with the at least one offer to purchase the property.

3. The method of claim 1, further comprising:
presenting, by the server, for display in a third region of the graphical user interface, a third interactive graphical component representing an offeror's investment and the point value,
wherein both the offeror's investment and the point value are associated with the at least one offer to purchase the property,
wherein the offeror's investment is displayed graphically on a third polygon extending from a second axis to represent the offeror's investment in the at least one offer to purchase the property, and
wherein the point value is displayed graphically on a fourth polygon extending from the second axis to represent the point value.

4. The method of claim 1, further comprising:
responsive to receiving, by the server, an interaction with the interactive graphical component, presenting, by the server, for display at least one of the plurality of offer inputs associated with the at least one offer to purchase the property.

5. The method of claim 1, further comprising:
presenting, by the server, for display a receipt notification on the user device, wherein the receipt notification is associated with the at least one updated offer to purchase the property.

6. The method of claim 1, wherein the plurality of offer inputs includes at least one of an offer price, a percent down payment, a days to close on escrow, a whether the at least one offer is contingent on a sale of another house, and a contingency time period.

7. A method of presenting for display a graphical user interface on a user device, the method comprising:
receiving, by a server, at least one offer to sell a property;
applying, by the server, a model configured to value the property and generate an affordability threshold by inputting a plurality of property inputs and a plurality of pricing inputs and outputting a comparable suggested value of the property, a lower comparable suggested value of the property, an upper comparable suggested value of the property, and the affordability threshold,
wherein the lower comparable suggested value is based at least on a comparable suggested value,
wherein the upper comparable suggested value is based at least on the comparable suggested value, and
wherein the affordability threshold is based at least on a user's maximum comfortable monthly payment;
presenting, by the server, for display in a first region of the graphical user interface, an interactive graphical component representing the at least one offer to sell the property, wherein the interactive graphical component includes, for the property:
a first polygon extending from an axis to represent an asking price of the property;
a second polygon extending from the axis to represent the comparable suggested value of the property;
a third polygon extending from the axis to represent the lower comparable suggested value of the property;
a fourth polygon extending from the axis to represent the upper comparable suggested value of the property; and
a first affordability threshold marker to represent the affordability threshold;
responsive to receiving, by the server, at least one offer to purchase the property:
applying, by the server, the model to the plurality of property inputs, the plurality of pricing inputs, and a plurality of offer inputs and outputting an updated affordability threshold; and
presenting, by the server, for display a fifth polygon extending from the axis to represent the at least one offer to purchase the property and a second affordability threshold marker in a position of the first affordability threshold marker to represent the updated affordability threshold.

8. The method of claim 7, further comprising:
responsive to receiving, by the server, a minimum offer increase threshold from a seller of the property, presenting, by the server, for display in a second region of the graphical user interface, a second interactive graphical component representing the at least one offer,
wherein the second interactive graphical component includes an offer price associated with the at least one offer to purchase the property, a target maximum offer associated with the upper comparable suggested value, and the minimum offer increase threshold.

9. The method of claim 7, further comprising:
presenting, by the server, for display in a third region of the graphical user interface, a third interactive graphical component representing an offer zone,
wherein the third interactive graphical component includes a third affordability threshold marker to represent at least the affordability threshold, and
wherein the third interactive graphical component includes an offer zone marker to represent at least one of the lower comparable suggested value and the upper comparable suggested value.

10. The method of claim 7, wherein the lower comparable suggested value is based at least in part on a first percentage less than the comparable suggested value, and
wherein the upper comparable suggested value is based at least in part on a second percentage greater than the comparable suggested value.

11. The method of claim 7, further comprising:
responsive to receiving, by the server, an updated offer to purchase the property:
applying, by the server, the model to an updated plurality of property inputs and an updated plurality of offer inputs to output an updated offer affordability threshold;
presenting, by the server, for display an updated fifth polygon in a position of the fifth polygon to represent the updated offer and a third affordability threshold marker in the position of the second affordability threshold marker to represent the updated offer affordability threshold; and
presenting, by the server, for display a notification on a second user device, wherein the notification is associated with the updated offer to purchase the property.

12. The method of claim 11, wherein the updated offer to purchase the property is higher than the at least one offer to purchase the property and exceeds a minimum offer increase threshold above the at least one offer.

13. A system for selling a property, the system comprising:
a first user device, configured to display a graphical user interface;
a second user device, configured to transmit at least one offer to purchase the property to a server;
the server, wherein the server is configured to:
communicate with the first user device and the second user device;
receive the at least one offer to purchase a purchase the property;
apply a model configured to value the at least one offer by inputting a plurality of offer inputs and outputting a point value based on the plurality of offer inputs;
present for display in a region of the graphical user interface, an interactive graphical component representing the at least one offer to purchase the property, wherein the interactive graphical component includes, for the at least one offer, a first polygon extending from an axis to represent a net offer price and a second polygon extending from the axis to represent the point value;
receive an updated offer associated with the at least one offer to purchase the property;
apply the model to an updated plurality of offer inputs to output an updated point value;
present for display a revised graphical user interface having a revised interactive graphical component to include a first revised polygon representing the updated point value in a position of the second polygon representing the point value for the updated offer.

14. The system of claim 13, wherein the server is further configured to:
present for display in a second region of the graphical user interface, a second interactive graphical component representing the at least one offer to purchase the property,
wherein the second interactive graphical component includes an offeror associated with the at least one offer to purchase the property, and
wherein the second interactive graphical component displays the plurality of offer inputs associated with the at least one offer to purchase the property.

15. The system of claim 13, wherein the server is further configured to:
present for display in a third region of the graphical user interface, a third interactive graphical component representing an offeror's investment and the point value,
wherein both the offeror's investment and the point value are associated with the at least one offer to purchase the property, and
wherein the offeror's investment is displayed graphically on a third polygon extending from a second axis to represent the offeror's investment in the at least one offer to purchase the property; and
wherein the point value is displayed graphically on a fourth polygon extending from the second axis to represent the point value.

16. The system of claim 13, the server further configured to:
responsive to receiving, by the server, an interaction with the interactive graphical component, present for display at least one of the plurality of offer inputs associated with the at least one offer to purchase the property, wherein the interactive graphical component is configured to receive a user interaction.

17. The system of claim 13, the server further configured to:
present for display a receipt notification on the first user device, wherein the receipt notification is associated with the updated offer to purchase the property.

18. The system of claim 13, wherein the plurality of offer inputs includes at least one of an offer price, a percent down payment, a days to close on escrow, a whether the at least one offer is contingent on a sale of another house, and a contingency time period.

19. The system of claim 13, wherein the second user device is configured to display a second graphical user interface.

20. The system of claim 13, the server further configured to:
present for display a notification on the second user device upon receiving an indication from the first user device that the at least one offer to purchase the property is accepted.
